(19) United States
(12) Patent Application Publication
(10) Pub. No.: US 2026/0262682 A1
(43) Pub. Date: Sep. 10, 2026

(54) EDIBLE PRODUCTS WITH IMPROVED PROPERTIES

(71) Applicant: ALFRED'S FOODTECH LTD, Netanya (IL)

(72) Inventors: Ronny REINBERG, Modiin (IL); Marina KIRJNER MATANA, Rosh HaaAyin (IL); Roey SOLOMONOVICH, Hod Hasharon (IL); Itamar CYMERMAN, Herzliya (IL)

(21) Appl. No.: 19/161,060

(22) PCT Filed: Feb. 29, 2024
(86) PCT No.: PCT/IL2024/050232

§ 371 Date: Aug. 29, 2025

Related U.S. Application Data
(60) Provisional application No. 63/487,721, filed on Mar. 1, 2023.

(51) Int. Cl. A23J 3/14; A23C 20/02; A23J 3/22; A23L 29/262

(52) U.S. Cl. CPC A23J 3/14; A23C 20/02; A23C 20/025; A23J 3/227; A23L 29/262

(57) ABSTRACT

The present disclosure relates to an edible product comprising at least one protein and at least one hydrocolloid polymer, wherein the at least one hydrocolloid polymer comprises at least one film forming polymer, and wherein the edible product has an improved sensory characteristic as compared to the sensory characteristics of the at least one protein, methods for the preparation of the edible products and uses thereof.

### TECHNOLOGICAL FIELD

The present disclosure relates to edible products having improved properties.

### BACKGROUND ART

References considered to be relevant as background to the presently disclosed subject matter are listed below:

Grandview Research. Protein ingredients market size, share and trends analysis report by product (plant protein, animal/dairy protein), by application (food & beverages, personal care and cosmetics), and segment forecasts, 2020-2027. 2020 [accessed Apr. 3, 2020]

Acknowledgment of the above references herein is not to be inferred as meaning that these are in any way relevant to the patentability of the presently disclosed subject matter.

### BACKGROUND

There is a constantly growing demand for protein ingredients such that the global protein ingredient market is expected to grow at a rate of 9.1% from 2020 to 2027 (Grandview Research, 2020). Some of the challenges associated with proteins reside in their persistent off-flavors that can be perceived by consumers.

### GENERAL DESCRIPTION

In accordance with some aspects, it is provided an edible product comprising at least one protein and at least one hydrocolloid polymer, wherein the edible product has an improved sensory characteristic as compared to the sensory characteristics of the at least one protein.

In accordance with some other aspects, it is provided an edible product comprising at least one protein and at least one hydrocolloid polymer, wherein the at least one hydrocolloid polymer is or comprises at least one film forming polymer, the at least one film forming polymer being in a total amount of at least 0.8 wt % out of the total weight of the edible product, the edible product has an improved one or more sensory characteristics as compared to the one or more sensory characteristics of the protein.

In accordance with some other aspects, it is provided an edible product comprising at least one protein and at least one hydrocolloid polymer, wherein the at least one hydrocolloid polymer is or comprises at least one film forming polymer, the at least one film forming polymer forms a continuous layered structure in the product.

In accordance with some other aspects, it is provided an edible product comprising at least one protein and at least one hydrocolloid polymer, wherein the at least one hydrocolloid polymer is or comprises at least one film forming polymer, the at least one film forming polymer forms a continuous layered structure in the edible product, the edible product has an improved one or more sensory characteristics as compared to the one or more sensory characteristics of the at least one protein.

In accordance with some further aspects, it is provided an edible product comprising at least one protein and at least one hydrocolloid polymer, wherein the at least one hydrocolloid polymer is or comprises at least one film forming polymer, wherein the at least one film forming polymer being in a total amount of at least 0.8 wt % out of the total weight of the edible product, wherein the at least one film forming polymer forms a continuous layered structure, the continuous layered structure holding the at least one protein.

In accordance with some further aspects, it is provided an edible product comprising at least one protein and at least one hydrocolloid polymer, wherein the at least one hydrocolloid polymer is or comprises at least one film forming polymer, wherein the at least one film forming polymer being in a total amount of at least 0.8 wt % out of the total weight of the edible product, wherein the at least one film forming polymer forms a polymeric matrix, the polymeric matrix holding within the matrix the at least one protein.

In accordance with some further aspects, it is provided an edible product comprising at least one protein and at least one hydrocolloid polymer, wherein the at least one hydrocolloid polymer is or comprises at least one film forming polymer, wherein the at least one film forming polymer being in a total amount of at least 0.8 wt % out of the total weight of the edible product, the at least one film forming polymer forms a continuous structure in the edible product.

In accordance with some further aspects, it is provided an edible product comprising at least one protein and at least one hydrocolloid polymer, wherein the at least one hydrocolloid polymer is or comprises at least one film forming polymer, wherein the at least one film forming polymer being in a total amount of at least 0.8 wt % out of the total weight of the edible product, and the at least one film forming polymer forms a continuous polymeric matrix, embedding within the at least one protein.

In accordance with some further aspects, it is provided an edible product being one or more of a plant-based chicken meat analogue product, a plant-based ham analogue product, a plant-based bacon analogue product, a plant-based cheese analogue product, a plant-based salmon meat analogue product, a plant-based yellow cheese analogue product, a plant-based hard cheese analogue product.

In accordance with yet some aspects, it is provided a method for preparing an edible product, the method comprising:
forming a film from a composition comprising at least one protein and at least one hydrocolloid polymer,
at least partially drying the film to obtain the edible product,
wherein the at least one hydrocolloid polymer is or comprises at least one film forming polymer, the at least one film forming polymer being in a total amount of at least 0.8 wt % out of the total weight of the edible product.

In accordance with yet some aspects, it is provided a method for preparing an edible product, the method comprising:
forming a film from a composition comprising at least one protein and at least one hydrocolloid polymer,
at least partially drying the film to obtain an edible dry film, and
milling the edible dry film to thereby obtain the edible product,
wherein the at least one hydrocolloid polymer is or comprises at least one film forming polymer, the at least one film forming polymer being in a total amount of at least 0.8 wt % out of the total weight of the edible product.

In accordance with yet some further aspects, it is provided an edible product obtained by the methods described herein, wherein the edible product is characterized by improved one or more sensory characteristics as compared to the one or more sensory characteristics of the at least one protein.

In accordance with yet some further aspects, it is provided an edible product obtainable by the methods described herein, wherein the edible product is characterized by improved one or more sensory characteristics as compared to the one or more sensory characteristics of the at least one protein.

### EMBODIMENTS

Some embodiments of this disclosure will now be described in the following numbered paragraph. The following description intends to add on the above general description and not limit it in any manner.

1. An edible product comprising at least one protein and at least one hydrocolloid polymer, wherein the at least one hydrocolloid polymer is or comprises at least one film forming polymer.

2. Use of at least one protein and at least one hydrocolloid polymer in the preparation of an edible product, wherein the at least one hydrocolloid polymer is or comprises at least one film forming polymer.

3. A method for preparing an edible product comprising:
forming a film from a composition comprising at least one protein and at least one hydrocolloid polymer,
at least partially drying the film to obtain the edible product.

4. A method for preparing an edible product comprising:
forming a film from a composition comprising at least one protein and at least one hydrocolloid polymer,
at least partially drying the film to obtain an edible dry film, and
milling the edible dry film to thereby obtain the edible product.

5. A method of improving sensory characteristic of an edible product, the method comprising:
forming a film from a composition comprising at least one protein and at least one hydrocolloid polymer,
at least partially drying the film to obtain the edible product, the product having improved sensory characteristic,
wherein the at least one hydrocolloid polymer is or comprises at least one film forming polymer.

6. A method of improving sensory characteristic of an edible product, the method comprising:
forming a film from a composition comprising at least one protein and at least one hydrocolloid polymer,
at least partially drying the film to obtain an edible dry film, and
milling the edible dry film to thereby obtain the edible product having improved sensory characteristic,
wherein the at least one hydrocolloid polymer is or comprises at least one film forming polymer.

7. The edible product of Embodiment 1 and/or the use of Embodiment 2 and/or the method of any one of Embodiments 3 to 6, wherein the edible product has an improved one or more sensory characteristics as compared to the one or more sensory characteristics of the protein.

8. The edible product and/or the use and/or the method of any one of Embodiments 1 to 7, wherein the at least one film forming polymer being in a total amount of at least 0.8 wt % out of the total weight of the product.

9. The edible product and/or the use and/or the method of any one of Embodiments 1 to 8, wherein the at least one film forming polymer forms a continuous layered structure in the product.

10. The edible product and/or the use and/or the method of any one of Embodiments 1 to 9, wherein the at least one protein forms a continuous layered structure in the product.

11. The edible product and/or the use and/or the method of any one of Embodiments 1 to 10, wherein the at least one film forming polymer forms a polymeric matrix.

12. The edible product and/or the use and/or the method of any one of Embodiments 1 to 11, wherein the polymeric matrix holding within the matrix the at least one protein.

13. The edible product and/or the use and/or the method of any one of Embodiments 1 to 12, wherein the at least one film forming polymer forms a continuous polymeric matrix, embedding (holding, embedding) within the at least one protein.

14. The edible product and/or the use and/or the method of any one of Embodiments 1 to 13, comprising at least one lipid.

15. The edible product and/or the use and/or the method of any one of Embodiments 1 to 14, wherein the one or more sensory characteristics is or comprises reduced protein taste profile.

16. The edible product and/or the use and/or the method of any one of Embodiments 1 to 15, wherein the protein taste profile comprises at least one of (i) reduced protein bitterness, (ii) reduced protein off-flavor, (iii) reduced protein aftertaste, (iv) reduced protein beany taste, or (v) any combination thereof.

17. The edible product and/or the use and/or the method of any one of Embodiments 1 to 16, wherein the at least one hydrocolloid polymer is a medium molecular weight polymer, a high molecular weight polymer or any combination thereof.

18. The edible product and/or the use and/or the method of any one of Embodiments 1 to 17, wherein the at least one hydrocolloid polymer has a viscosity of at least 100 cP at 25° C., when dissolved in water, at a concentration of about 1% (w/v).

19. The edible product and/or the use and/or the method of any one of Embodiments 1 to 18, wherein the at least one hydrocolloid polymer has a viscosity of at least 100 cP at 25° C., when dissolved in water, at a concentration of about 2% (w/v).

20. The edible product and/or the use and/or the method of any one of Embodiments 1 to 19, wherein the at least one hydrocolloid polymer has a viscosity of at least 1,000 cP at 25° C., when dissolved in water, at a concentration of about 1% (w/v).

21. The edible product and/or the use and/or the method of any one of Embodiments 1 to 20, wherein the at least one hydrocolloid polymer has a viscosity of at least 1,000 cP at 25° C., when dissolved in water, at a concentration of about 2% (w/v).

22. The edible product and/or the use and/or the method of any one of Embodiments 1 to 21, wherein the at least one hydrocolloid polymer is characterized by a viscosity at 25° C., of between about 100 cP and about 15,000 cP.

23. The edible product and/or the use and/or the method of any one of Embodiments 1 to 22, wherein the at least one hydrocolloid polymer is in an amount of between about 0.1% and about 50% out of the total weight of the edible product.

24. The edible product and/or the use and/or the method of any one of Embodiments 1 to 23, wherein the at least one hydrocolloid polymer is in an amount of between about 0.1% and about 40% out of the total weight of the edible product.

25. The edible product and/or the use and/or the method of any one of Embodiments 1 to 24, wherein the at least one hydrocolloid polymer is in an amount of between about 3% and about 40% out of the total weight of the edible product.

26. The edible product and/or the use and/or the method of any one of Embodiments 1 to 25, wherein the at least one film forming polymer being in a total amount of at least 0.1 wt % out of the weight % of the hydrocolloid polymer.

27. The edible product and/or the use and/or the method of any one of Embodiments 1 to 26, wherein the at least one film forming polymer being in a total amount of at least 1 wt % out of the weight % of the hydrocolloid polymer.

28. The edible product and/or the use and/or the method of any one of Embodiments 1 to 27, wherein the at least one film forming polymer being in a total amount of at least 5 wt % out of the weight % of the hydrocolloid polymer.

29. The edible product and/or the use and/or the method of any one of Embodiments 1 to 28, wherein the at least one film forming polymer being in a total amount of between about 0.1 wt % and about 100% out of the weight (wt %) of the hydrocolloid polymer.

30. The edible product and/or the use and/or the method of any one of Embodiments 1 to 28, wherein the at least one film forming polymer being in a total amount of between about 1 wt % and about 100% out of the weight (wt %) of the hydrocolloid polymer.

31. The edible product and/or the use and/or the method of any one of Embodiments 1 to 30, wherein the at least one film forming polymer is or comprises a polysaccharide.

32. The edible product and/or the use and/or the method of any one of Embodiments 1 to 31, wherein the polysaccharide is or at least one of methyl cellulose (MC), hydroxypropylmethylcellulose (HPMC), carboxymethylcellulose (CMC), hydroxyethylcellulose, carboxyethylcellulose, chitosan, methylcellulose, ethylcellulose, xanthan gum, guar gum, gellan gum, gum arabic, carageenan, alginic acid (and its salts), acacia or a combination thereof.

33. The edible product and/or the use and/or the method of any one of Embodiments 1 to 32, wherein the polysaccharide is at least one of MC, HPMC, CMC, xanthan gum, guar gum and or combination of same.

34. The edible product and/or the use and/or the method of any one of Embodiments 1 to 33, wherein the polysaccharide comprises cellulose.

35. The edible product and/or the use and/or the method of any one of Embodiments 1 to 34, wherein the polysaccharide is or at least one of MC, HPMC, CMC, hydroxyethylcellulose, carboxyethylcellulose, methylcellulose, ethylcellulose or a combination of thereof.

36. The edible product and/or the use and/or the method of any one of Embodiments 1 to 35, wherein the cellulose is one or more of MC, CMC, HPMC or a combination thereof.

37. The edible product and/or the use and/or the method of any one of Embodiments 1 to 36, wherein the cellulose is MC having a viscosity of at least about 4,000 cP at 25° C., when dissolved in water at a concentration of about 2 wt %.

38. The edible product and/or the use and/or the method of any one of Embodiments 1 to 37, wherein the cellulose is HPMC having a viscosity at 25° C., of at least about 10,000 cP, or about 15,000 cP, or between about 10,000 cP and about 15,000 cP, when dissolved in water at a concentration of 2 wt %.

39. The edible product and/or the use and/or the method of any one of Embodiments 1 to 38, wherein the cellulose is CMC having a viscosity at 25° C., of at least about 1,500 cP, or between about 1,500 cP and about 3,000 cP, when dissolved in water at a concentration of 1 wt %.

40. The edible product and/or the use and/or the method of any one of Embodiments 1 to 39, wherein the cellulose is or comprises a nature-derived polysaccharide.

41. The edible product and/or the use and/or the method of any one of Embodiments 1 to 40, wherein the nature-derived polysaccharide is one or more of xanthan gum, guar gum or a combination thereof.

42. The edible product and/or the use and/or the method of any one of Embodiments 1 to 41, wherein the cellulose is xanthan gum having a viscosity at 25° C., of between 1,000 cP and about 2,000 cP, when dissolved in water at a concentration of 1 wt %.

43. The edible product and/or the use and/or the method of any one of Embodiments 1 to 42, wherein the cellulose is guar gum having a viscosity at 25° C., of at least about 3,000 cP or between about 3,000 cP and about 5,000 cP, when dissolved in water at a concentration of 1 wt %.

44. The edible product and/or the use and/or the method of any one of Embodiments 1 to 43, comprising a combination of MC and HPMC.

45. The edible product and/or the use and/or the method of any one of Embodiments 1 to 44, comprising a combination of MC and CMC.

46. The edible product and/or the use and/or the method of any one of Embodiments 1 to 45, comprising a combination of HPMC and CMC.

47. The edible product and/or the use and/or the method of any one of Embodiments 1 to 46, comprising a combination of MC, CMC and HPMC.

48. The edible product and/or the use and/or the method of any one of Embodiments 1 to 47, wherein the at least one film forming polymer being in a total amount of at least 1 wt % out of the total weight of the product.

49. The edible product and/or the use and/or the method of any one of Embodiments 1 to 48, wherein the at least one film forming polymer being in a total amount of between about 1 wt % and about 50 wt % out of the total weight of the product.

50. The edible product and/or the use and/or the method of any one of Embodiments 1 to 49, wherein the at least one film forming polymer being in a total amount of between about 1 wt % and about 40 wt % out of the total weight of the product.

51. The edible product and/or the use and/or the method of any one of Embodiments 1 to 50, wherein the at least one film forming polymer being in a total amount of between about 1 wt % and about 25 wt % out of the total weight of the product.

52. The edible product and/or the use and/or the method of any one of Embodiments 1 to 51, wherein the protein is a plant-based protein.

53. The edible product and/or the use and/or the method of any one of Embodiments 1 to 52, wherein the plant-based protein comprises a protein selected from the group consisting of soy, wheat, legume, soy, pea, canola, chickpea, fava bean, lentil, lupin, mung bean, navy bean, peanut, sunflower, almond, corn, oat, potato, quinoa, rice, sorghum, seitan, seeds of sort-chia, hemp, beans of sort-edamame bean, black bean, kidney bean, nuts of sort-cashews, pistachios, walnut, hazelnuts, flax and any combination of same.

54. The edible product and/or the use and/or the method of any one of Embodiments 1 to 53, wherein the plant-based protein legume protein and/or bean protein.

55. The edible product and/or the use and/or the method of any one of Embodiments 1 to 54, wherein the legume protein or bean protein is selected from the group consisting of soy protein, pea protein, chickpea protein, lupine protein, mung-bean protein, kidney bean protein, black bean protein, alfalfa protein and any combination of same.

56. The edible product and/or the use and/or the method of any one of Embodiments 1 to 55, wherein the plant-based protein comprises at least pea protein.

57. The edible product and/or the use and/or the method of any one of Embodiments 1 to 56, wherein the plant-based protein comprises at least chickpea protein.

58. The edible product and/or the use and/or the method of any one of Embodiments 1 to 57, wherein the plant-based protein comprises at least lentil protein.

59. The edible product and/or the use and/or the method of any one of Embodiments 1 to 58, wherein the at least protein being in a total amount of at least about 1 wt % out of the total weight of the product.

60. The edible product and/or the use and/or the method of any one of Embodiments 1 to 59, wherein the at least protein being in a total amount of at least about 2 wt % out of the total weight of the product.

61. The edible product and/or the use and/or the method of any one of Embodiments 1 to 60, wherein the at least protein being in a total amount of between about 1 wt % and about 98 wt % out of the total weight of the product.

62. The edible product and/or the use and/or the method of any one of Embodiments 1 to 61, wherein the at least protein being in a total amount of between about 2 wt % and about 90 wt % out of the total weight of the product.

63. The edible product and/or the use and/or the method of any one of Embodiments 1 to 62, wherein the at least protein being in a total amount of between about 2 wt % and about 35 wt % out of the total weight of the product.

64. The edible product and/or the use and/or the method of any one of Embodiments 1 to 63, wherein the protein is from an animal source.

65. The edible product and/or the use and/or the method of any one of Embodiments 1 to 64, wherein the protein from an animal source is at least one of (i) at least one meat protein, (ii) at least one seafood protein, (iii) at least one dairy protein, (iv) at least one egg protein, (v) at least one poultry protein, (vi) at least one beef protein or (vii) any combination thereof.

66. The edible product and/or the use and/or the method of any one of Embodiments 1 to 65, wherein the at least one lipid is or comprises a plant derived oil.

67. The edible product and/or the use and/or the method of any one of Embodiments 1 to 66, wherein the plant derived oil is selected from the group consisting of canola oil, coconut oil, and any combination of same.

68. The edible product and/or the use and/or the method of any one of Embodiments 1 to 67, being in one or more of (i) in a form of a powder, (ii) in a form of a film, (iii) in a form of crude material, (iv) in a form of a block, (v) in a form of a texturized protein blend.

69. The edible product and/or the use and/or the method of any one of Embodiments 1 to 68 being one or more of a plant-based chicken meat analogue product, a plant-based ham analogue product, a plant-based bacon analogue product, a plant-based cheese analogue product, a plant-based salmon meat analogue product, a plant-based yellow cheese analogue product, a plant-based hard cheese analogue product.

70. The edible product and/or the use and/or the method of any one of Embodiments 1 to 69, comprising about 13 wt % MC and about 87 wt % protein.

71. The edible product and/or the use and/or the method of any one of Embodiments 1 to 70, comprising about 13 wt % MC and 87 wt % protein, the product is in powder form.

72. The edible product and/or the use and/or the method of any one of Embodiments 1 to 71, comprising about 13 wt % MC and 87 wt % pea protein.

73. The edible product and/or the use and/or the method of any one of Embodiments 1 to 72, comprising about 9 wt % cellulose and about 91 wt % protein.

74. The edible product and/or the use and/or the method of any one of Embodiments 1 to 73, comprising about 1.5 wt % MC, about 1.5 wt % HPMC and about 91 wt % protein, the product is in powder form.

75. The edible product and/or the use and/or the method of any one of Embodiments 1 to 74, comprising about 1.5 wt % MC, about 1.5 wt % HPMC and about 91 wt % pea protein.

76. The edible product and/or the use and/or the method of any one of Embodiments 1 to 75, comprising about 2.6 wt % cellulose, and about 15.5 wt % protein.

77. The edible product and/or the use and/or the method of any one of Embodiments 1 to 76, comprising about 2.6 wt % MC, and about 15.5 wt % protein.

78. The edible product and/or the use and/or the method of any one of Embodiments 1 to 77, comprising about 2.6 wt % cellulose and about 15.5 wt % pea protein.

79. The edible product and/or the use and/or the method of any one of Embodiments 1 to 78, comprising about 2.6 wt % MC and about 15.5 wt % pea protein and the edible product is a cheese-like product.

80. The edible product and/or the use and/or the method of any one of Embodiments 1 to 79, comprising about 4.5 wt % cellulose, and about 15.5 wt % protein.

81. The edible product, the use and/or the method of any one of Embodiments 1 to 80, comprising about 3 wt % MC, about 1.5 wt % HPMC and about 15.5 wt % protein.

82. The edible product and/or the use and/or the method of any one of Embodiments 1 to 81, comprising about 4.5 wt % cellulose and about 15.5 wt % pea protein.

83. The edible product and/or the use and/or the method of any one of Embodiments 1 to 82, comprising about 3 wt % MC, about 1.5 wt % HPMC and about 15.5 wt % pea protein and the edible product is a prosciutto-like product.

84. The edible product and/or the use and/or the method of any one of Embodiments 1 to 83, comprising about 1.6 wt % cellulose, and about 18.5 wt % protein.

85. The edible product and/or the use and/or the method of any one of Embodiments 1 to 84, comprising about 1.6 wt % MC and about 18.5 wt % protein.

86. The edible product and/or the use and/or the method of any one of Embodiments 1 to 85, comprising about 1.6 wt % cellulose and about 18.5 wt % lentil protein.

87. The edible product and/or the use and/or the method of any one of Embodiments 1 to 86, comprising about 1.6 wt % MC and about 18.5 wt % lentil protein and the edible product is a gouda-like product.

88. The edible product and/or the use and/or the method of any one of Embodiments 1 to 87, being free of a flavor masking agent.

89. The edible product and/or the use and/or the method of any one of Embodiments 1 to 88, being a minimally processed food ingredient.

90. The edible product and/or the use and/or the method of any one of Embodiments 1 to 89 comprising an amount/level of at least one amino acid as in the protein.

91. The edible product and/or the use and/or the method of any one of Embodiments 1 to 90, wherein the at least one of the at least one amino acid is an essential amino acid.

92. The edible product and/or the use and/or the method of any one of Embodiments 1 to 91, wherein the forming of the film is by spreading a mass of the emulsion composition onto a film forming bed or within a mold.

93. The edible product and/or the use and/or the method of any one of Embodiments 1 to 92, comprising controlling thickness of the film.

94. The edible product and/or the use and/or the method of any one of Embodiments 1 to 93, wherein the controlling of thickness of the film is by using a gap applicator.

95. The edible product and/or the use and/or the method of any one of Embodiments 1 to 94, wherein the at least partially drying of the film is by exposing the film to a controlled heat.

96. The edible product and/or the use and/or the method of any one of Embodiments 1 to 95, wherein the at least partially drying the film is by any one or combination of heating the film within an oven, exposing the film to drying air, exposing the film to infrared (IR) radiation, heating on a plate or heating within a microwave.

97. The edible product and/or the use and/or the method of any one of Embodiments 1 to 96, wherein the at least partially drying of the film is until water content within the film is between 0% and 90%.

98. The edible product and/or the use and/or the method of any one of Embodiments 1 to 97, wherein the at least partially drying of the film is until water content within the film is between 0.5% and 90%.

99. The edible product and/or the use and/or the method of any one of Embodiments 1 to 98, wherein the at least partially drying of the film is until water content within the film is between 1% and 80%.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a graph showing averages scores (in Y-axis) of sensory parameters of two formulations as determined by a panel of tasters.

FIG. 2 is an exemplary image of an edible product having a form of a film prepared in accordance with some embodiments.

FIG. 3 is an exemplary image of an edible product in a form of a powder (food ingredient) prepared in accordance with some embodiments.

FIG. 4 is an exemplary image of a mozzarella like cheese analogue product prepared in accordance with some embodiments.

FIG. 5 is a spider plot of gouda like cheese analogue product and prosciutto like analogue product prepared in accordance with some embodiments.

FIG. 6 is a confocal microscopy image showing calcofluor-white staining in a gouda like cheese analogue product prepared in accordance with some embodiments; arrows point of positive signal.

FIG. 7 is a bright field microscopy image showing fast green staining in gouda like cheese analogue product prepared in accordance with some embodiments; black arrows point of positive signal, magnification 20×.

FIGS. 8A to 8C are bright field microscopy images of gouda like cheese analogue product prepared in accordance with some embodiments showing Oil Red O staining (FIG. 8A); Sudan Black staining (FIG. 8B); Sudan Black and Fast Green staining (FIG. 8C), black arrows point at positive signal, pink arrows point at Fast green signal and orange arrows points at Sudan Black signal in Sudan Black and Fast Green Stain.

FIGS. 9A to 9C are confocal microscopy images of gouda like cheese analogue product prepared in accordance with some embodiments showing Fast Green staining (FIG. 9A); Oil Red O staining (FIG. 9B); Sudan Black staining (FIG. 9C), arrows point at the positive signal.

### DETAILED DESCRIPTION OF EMBODIMENTS

Proteins, especially those from plant sources, are characterized in some cases, by having a strong, bitter, or earthy taste. Yet, due to their high nutritional value and in order to make food products comprising these plant proteins, palatable, it is desirable to reduce the taste of such proteins.

Common techniques that are used in order to improve the taste of proteins include, inter alia, hydrolysis, enzymatic modification, heat treatment as well as addition of flavorings and texture modification.

The present disclosure is based on the surprising findings that combinations of edible proteins and polymers, including, inter alia, film forming polymers, have improved properties as compared to the origin protein.

As shown herein below, films, dry powders, ready for use food products or ready to eat food products prepared from the films formed from mixture (such as emulsions) of edible proteins and polymers, have improved properties such as taste, as compared to the origin protein. It was also surprisingly found that these improved properties were not detected in physical mixtures of the protein and the polymers or in extruded preparations of the protein.

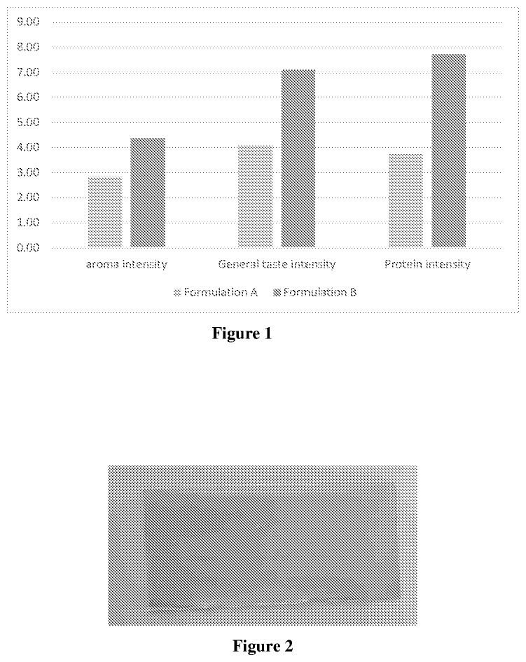

As shown in Example 1 (FIG. 1), a protein-polymer powder prepared by grinding a film was characterized by a significantly lower protein intensity as compared to the protein intensity of a protein-polymer powder having the same components but prepared by mixing the dried components.

As shown in Example 5, providing information on an edible product in accordance with the present disclosure, morphology, structure, and distribution of cellulose and protein in a cheese-like product prepared from film, showed a continuous layered organized structure suggesting that the cellulose polymer holds the protein, optionally forms a polymeric matrix holding within (embedding, encapsulating) the matrix the at least one protein.

These findings suggested that in a film and/or a powder prepared from the film, the polymer and the protein adopt a unique structure configuration allowing organization of the protein within the polymers and hence masking the protein taste and improving the sensory characteristics of the protein.

This feature is highly important as it allows preparation of edible products having high amounts of protein.

As appreciated, edible products, such as dry powders can be also produced by other methods. Yet, application of such methods, including, inter alia, spray-drying, to produce powders from high or medium molecular weight mixtures such as those described herein is challenging. For example, the high viscosity of the spraying solution in case of medium or high molecular weight polymers makes this method not applicable. Contrary to the above and as shown herein, the inventors were able to allow neutral flavor profiling that eliminated problematic flavors.

Based on the above, the inventors envisaged that the formed film can be used as is as a food product, including, inter alia, as a cheese like food product, as a cold-cut like food product, as a fish like food product, as a chicken like food product, as a pork-like food product, or as a sea food like food product. Alternatively, or additionally, the film may be milled to obtain a powder. In accordance with the present disclosure, both the film, powder or any physical state form or modification thereof used as a food product or in the preparation of multiple food products is characterized by improved sensory characteristics as compared to the origin protein.

Hence, in accordance with some aspects, the present disclosure provides an edible product comprising at least one protein and at least one hydrocolloid polymer, the at least one hydrocolloid polymer is or comprises at least one film forming polymer, the at least one film forming polymer being in a total amount of at least 0.8 wt % out of the total weight of the edible product, the edible product has an improved sensory characteristic as compared to the sensory characteristics of the at least one protein.

For the sake of simplicity and as noted herein, when referring in the context of the present disclosure to an edible product it is to be understood as encompassing a food ingredient that may be used per se or may be used for the preparation of a variety of diverse food product that may be considered as a ready for use/ready to eat edible food product (finished products). In other words, the edible product in accordance with some examples of the present disclosure denotes an edible food product that may be consumed as obtained or may serve in preparation or be part of (comprised) other food products, as described herein, for example a cheese-like products, a meat-like product and the like.

In some examples, the edible product is a food ingredient. As used herein the term food ingredient may be considered as a food substance that may be consumed per se (as is) or may be added to or be part of a food product during preparation of processing.

In some examples, the edible product is in a form of a powder.

In some examples, the edible product is in a form of a film.

In some examples, the edible product is in a form of a crude material.

In some examples, the edible product is in a form of a block.

In some examples, the edible product is in a form of a texturized protein blend.

The film as used herein it is to be understood to encompass a three-dimensional product having a height (thickness), length and width.

The block as used herein refers to a three-dimensional structure with specific dimensions, having, for example a rectangular or cylindrical shape as further detailed herein.

The present disclosure provides in accordance with some aspects, an edible product comprising at least one protein and at least one polymer, wherein the at least one polymer is or comprises at least one medium molecular weight polymer and/or high molecular weight polymer, wherein the edible product has an improved flavor profile as compared to the flavor profile of the protein.

In accordance with some other aspect, it is provided an edible product comprising at least one protein and at least one hydrocolloid polymer, wherein the edible product has an improved sensory characteristic as compared to the sensory characteristics of the at least one protein.

In the following text, when referring to the edible product it is to be understood as also referring to the food ingredient, food product, ready to use food product, ready to eat food product, use and method disclosed herein. Thus, whenever providing a feature with reference to the edible product, it is to be understood as defining the same feature with respect to the food ingredient, food product, ready to use food product, ready to eat food product, use or method mutatis mutandis.

As described herein, the edible product is characterized by a unique structure morphology.

In accordance with some embodiments that may be considered as aspects of the present disclosure, the at least one film forming polymer forms a continuous layered structure in the product.

In accordance with some embodiments that may be considered as aspects of the present disclosure, the at least one film forming polymer and the at least one protein form a continuous layered structure in the product.

The continuous layered structure of the edible product may be viewed by various imaging methods. In some examples, the structure of the edible product may be viewed and analyzed by bright field microscopy and/or confocal laser scanning microscopy (CLSM).

In some examples, the structure of the at least one protein and/or the at least one film forming polymer may be viewed and analyzed by bright field microscopy and/or CLSM.

In some examples, the structure of the at least one protein and/or the at least one film forming polymer may be viewed and analyzed by bright field microscopy and/or CLSM by applying specific antibodies as described herein below.

In some examples, the structure of the lipid may be viewed and analyzed by bright field microscopy and/or CLSM by applying specific antibodies as described herein below.

As shown below in Example 5, application of specific staining enabled visualization of the overall structure of the edible product, including, protein, film forming polymer, lipids (e.g. neutral lipids) and/or phospholipids.

In accordance with some embodiments that may be considered as aspects of the present disclosure, the at least one film forming polymer in the edible product forms a polymeric matrix holding within the matrix the at least one protein.

In accordance with some embodiments that may be considered as aspects of the present disclosure, the at least one film forming polymer in the edible product forms a continuous structure in the product.

In accordance with some embodiments that may be considered as aspects of the present disclosure, the at least one film forming polymer in the edible product forms a continuous polymeric matrix embedding within the at least one protein.

In accordance with some examples, the edible product comprises at least one lipid.

Hence, in accordance with some aspects, it is provided an edible product comprising at least one protein, at least one hydrocolloid polymer and at least one lipid, wherein the at least one hydrocolloid polymer comprises at least one film forming polymer, the at least one film forming polymer being in a total amount of at least 0.8 wt % out of the total weight of the edible product, the product has an improved one or more sensory characteristic as compared to the one or more sensory characteristics of the at least one protein.

As described herein, the edible product has an improved one or more sensory characteristics as compared to the one or more sensory characteristics of the protein from which the edible product was prepared. It should be noted that in examples, in which the edible product comprises one or more proteins, the edible product has an improved sensory characteristic as compared to the one or more original proteins.

When referring herein to improved sensory characteristic of the edible product, such a comparison may be done to the protein (one or more) from which the edible product was prepared per se (i.e. without the polymer or any other component of the edible product, alternatively or additionally, the comparison may be done to an edible product prepared by method others the methods described herein, alternatively or additionally, the comparison may be done to an edible product comprising a film forming polymer in an amount of at most 0.8 wt %, at times at most 0.5 wt % out of the total weight of the edible product.

An improved sensory characteristic may result in an increase, elevation, enhancement, of about 5%, 10%, 15%, 20%, 25%, 30%, 35%, 40%, 45%, 50%, 55%, 60%, 65%, 70%, 75%, 80%, 85%, 90%, 95%, 99%, or more specifically 100% of one or more characteristic in the edible product as compared to the protein as described herein below.

Additionally or alternatively an improved sensory characteristic may result in an increase, elevation, enhancement, of about 5%, 10%, 15%, 20%, 25%, 30%, 35%, 40%, 45%, 50%, 55%, 60%, 65%, 70%, 75%, 80%, 85%, 90%, 95%, 99%, or more specifically 100% of the number of tasters evaluating the edible product as compared to the number of tasters evaluating the protein as described herein below.

In some examples, the improved sensory characteristic of the edible product is as compared to the protein from which the edible product was prepared being a protein isolate, a protein concentrate, a flour comprising the protein or a raw product comprising the protein. In some examples, the improved sensory characteristic of the edible product is as compared to a butter comprising the protein or a spread comprising the protein. In some examples, the improved sensory characteristic of the edible product is as compared to a sesame spread (Tahini) comprising the protein. In some examples, the improved sensory characteristic of the edible product is as compared to an almond butter.

In some examples, the improved sensory characteristic of the edible product is as compared to an edible product prepared by mixing the components.

In some examples, the improved sensory characteristic of the edible product is as compared to an edible product prepared in a method that essentially do not form a film.

In some examples, the improved sensory characteristic of the edible product is as compared to an edible product comprising at least one film forming polymer in an amount of at most 0.8 wt %, at times at most 0.7 wt %, at times at most 0.6 wt %, at times at most 0.5 wt % out of the total weight of the product.

As used herein the term “sensory characteristics” refers to a collection of sensory characteristics that are evaluated for food products (e.g. food and beverages), and that may be used in the optimization of food products. In the context of the present disclosure, the flavor profile comprises the characterization of one or more of flavor, aroma, and texture.

The sensory characteristics may be used in optimization of food products. In the context of the present disclosure, the sensory characteristics comprises characterization of one or more of taste, smell (aroma), appearance (visual) and texture (mouthfeel).

In some examples, the sensory characteristic is smell (aroma).

In some examples, the sensory characteristic is appearance.

In some examples, the sensory characteristic is texture.

In some examples, the sensory characteristic is taste.

As used herein taste refers to a perception stimulated when a substance in the mouth reacts chemically with taste receptor cells located on taste buds in the oral cavity, mostly on the tongue. The taste receptors in the mouth sense the five basic tastes: sweetness, sourness, saltiness, bitterness, and savoriness.

In some examples, the flavor profile comprises one or more of sweetness, sourness, bitterness, umami, saltiness, aroma intensity, aroma quality, mouthfeel, off-flavor, and aftertaste.

In some examples, the sensory characteristics is or comprises reduced protein taste profile.

The sensory characteristics may be regarded as a flavor profile of the edible product.

The term “improved flavor profile” as used herein refers to making at least one of the flavor profile characteristics better or more desirable by reducing or eliminating the undesirable flavor profile of a protein and making the protein and any product derived therefrom palatable.

Hence, an improved flavor profile of a protein may be by one or more of the following characteristics: (i) reduced protein bitterness, (ii) reduced protein off-flavor, (iii) reduced protein aftertaste, (iv) reduced protein beany taste, or (v) any combination thereof.

A reduced effect (e.g. reduced protein bitterness) may result in a decrease, lowering, minimized effect, of about 5%, 10%, 15%, 20%, 25%, 30%, 35%, 40%, 45%, 50%, 55%, 60%, 65%, 70%, 75%, 80%, 85%, 90%, 95%, 99%, or more specifically 100% of the effect in the edible product as compared to the protein as described herein.

Additionally or alternatively a reduced effect (e.g. reduced protein bitterness) may result in a decrease of about 5%, 10%, 15%, 20%, 25%, 30%, 35%, 40%, 45%, 50%, 55%, 60%, 65%, 70%, 75%, 80%, 85%, 90%, 95%, 99%, or more specifically 100% of the number of tasters evaluating the edible product as compared to the number of tasters evaluating the protein as described herein.

As appropriated, the above characteristics defining the improved flavor profile may overlap, for example, reduced bitterness may be partially as masked taste.

In some examples, improved flavor profile is reducing/eliminating bitter taste associated with a protein. Bitter taste is one of the five basic tastes that humans can perceive and is often associated with substances that are alkaline or acidic in nature. The sensation of bitterness is triggered by specific taste receptors on the tongue and palate, which are activated by chemical compounds called bitterants.

In some examples, an improved flavor profile is reducing/eliminating off-flavor associated with a protein. Off-flavor refers to trace of a bad or undesirable quality or substance.

In some examples, an improved flavor profile is reducing/eliminating the aftertaste of a protein. Aftertaste refers to the left-over flavor without the input of the other sensory systems.

In some examples, improved flavor profile is by reducing/eliminating a beany taste of a protein. Beany taste as used herein refers to nutty, earthy, or grassy flavor or aroma of a protein.

In some examples, an improved flavor profile is by reducing/eliminating a long-lasting taste of a protein. As used herein, long lasting taste refers to flavor/taste that lingers on the tongue for an extended period of time.

As used herein, improved flavor profile of a protein refers to a better profile of a protein in a formed film as well as an edible product or a food product comprising the same relative to the protein not in a film or powder form.

Analysis of the flavor profile can be done by various methods, including, inter alia, in methods that involve analysis of one or more of the taste, aroma, and texture components of a food or beverage in order to provide a picture of the flavor profile of a product. As appreciated, such information may be used to understand its overall sensory experience and identify areas of improvement.

The flavor profile method typically involves a panel of sensory analysts who evaluate the product. As described in the Examples, the flavor profile of the edible product and/or any food product as described herein, is evaluated by a sensory panel.

In some embodiments, the edible product is characterized by having similar nutritional values as the origin protein. It was suggested that the edible product described herein is minimally processed. In some embodiments, the edible product comprises an amount/level of at least one amino acid as in the protein.

As appreciated, amino acids are organic compounds that contain an amino group (—NH2) and a carboxyl group (—COOH) attached to a central carbon atom, as well as a side chain group (R group) that is specific to each amino acid and are the building blocks of proteins.

In some embodiments, the edible product comprises an amount/level of at least one amino acid as in the protein, the amino acid is at least one of alanine (Ala, A), Arginine (Arg, R), Asparagine (Asn, N), Aspartic acid (Asp, D), Cysteine (Cys, C), Glutamine (Gln, Q), Glutamic acid (Glu, E), Glycine (Gly, G), Histidine (His, H), Isoleucine (Ile, I), Leucine (Leu, L), Lysine (Lys, K), Methionine (Met, M), Phenylalanine (Phe, F), Proline (Pro, P), Serine (Ser, S), Threonine (Thr, T), Tryptophan (Trp, W), Tyrosine (Tyr, Y), Valine (Val, V) or any combination thereof.

In some embodiments, the edible product comprises an amount/level of at least one essential amino acid as in the origin protein.

In some embodiments, the edible product comprises an amount/level of at least one amino acid as in the protein, the amino acid is at least one of histidine, isoleucine, leucine, lysine, methionine, phenylalanine, threonine, tryptophan, valine or any combination thereof.

In some embodiments, the edible product comprises an amount/level of lysine as in the origin protein.

In some examples, the edible product comprising of at least one polymer and of at least one protein is in a form of a solid solution.

As used herein the term solid solution refers to a homogeneous mixture of the at least one polymer and the at least one protein forming a single-phase system in which the at least one polymer and the at least one protein form interactions. The solid solution is known as having different chemical features as compared to the polymer or protein forming it. At times, a solid solution may be considered as mixture of two crystalline solids that coexist as a new crystalline solid.

A solid solution can be characterized using Differential Scanning calorimetry (DSC) that can be used to determine the melting point and/or glass transition temperature of the polymer, the protein, and the formed solid solution. It was suggested that the solid solution has a transition temperature different than the transition temperature of each one of the components, i.e., polymer and protein. It should be noted that the difference in transition temperature can be evidence of solid solution formation.

Without being bound by theory, it was suggested that the solid solution has different features, as compared to the origin protein, including, inter alia, different binding affinity to receptors that leads to an improved flavor.

In some examples, the edible product comprising the at least one polymer and the at least one protein is in a form of a solid dispersion.

As used herein the term solid dispersion refers to a mixture of the at least one polymer and the at least one protein forming a solid complex.

A solid dispersion can be characterized by using scanning electron microscopy (SEM) by providing images of the atom's arrangement.

Without being bound by theory, it was suggested that the solid dispersion may have a different effect on taste receptors as compared to the origin protein, including, inter alia, different binding affinity to receptors that lead to an improved flavor.

As noted above, in some examples, the edible product comprising the at least one protein embedded within the polymeric matrix formed by the at least one film forming polymer. Without being bound by theory, it was suggested that the polymer that forms a polymeric matrix holds the protein within this matrix. In other words, the edible protein is at least partially embedded (entrapped) within the polymeric matrix.

Without being bound by theory, it was suggested that the polymeric matrix (e.g. in the form of a continuous layered structure) confines (holds) the protein within and reducing/preventing the protein from contacting the taste buds on the tongue by slow and controlled release of the protein from the polymeric matrix in the oral cavity, and hence reducing the perception of taste. It was also suggested that the protein is released from the polymeric matrix in the stomach, where it becomes available. Such features can be monitored by dissolution method that simulates the dissolution in the oral cavity.

In some examples, the edible product is in a form of layers. Without being bound by theory, it was suggested that the polymer that forms layers, such that the protein is held within the layers of the polymer. This form can be characterized by using light microscope or stereoscope.

As described herein, the edible product comprises at least one hydrocolloid polymer.

As appreciated, hydrocolloids encompass a heterogeneous group of hydrophilic biopolymers with medium and high molecular weight that can be dissolved or dispersed in water to form a viscous or gel-like solution.

The term “hydrocolloid polymer” used herein denotes any polymer or combination of polymers, which may be natural, synthetic and/or semi-synthetic that forms is capable, under appropriate conditions, to form into a hydrocolloid polymer matrix. Hydrocolloids are often called hydrophilic polymer that generally contain many hydroxyl groups (e.g. polysaccharides) and may be polyelectrolytes, for example, alginate, carrageenan, methylcellulose, hydroxypropylmethylcellulose, hydroxyproplylcellulose, carboxymethylcellulose, gum arabic, chitosan, pectin, and xanthan gum.

The at least one polymer may be a medium molecular weight polymer, a high molecular weight polymer or any combination thereof.

As appreciated, a medium molecular weight polymer is a polymer with a molecular weight between 10,000 and 100,000 g/mol, whereas a high molecular weight polymer is a polymer with a molecular weight greater than 100,000 g/mol.

In some examples, the polymer is a medium molecular weight polymer.

In some examples, the polymer is a high molecular weight polymer.

Polymers are at times characterized by their viscosity. As appreciated, the viscosity of a polymer is a measure of its internal resistance to flow when subjected to a force.

In some examples, the at least one hydrocolloid polymer is characterized by a viscosity of at least about 100 cP at 25° C., when dissolved in water, at a concentration of about 1% (w/v); at times of at least about 200 cP, at times at least about 300 cP, at times at least about 400 cP, at times at least about 500 cP, at times at least about 700 cP, at times at least about 800 cP, at times at least about 1000 cP, at times at least about 2000 cP, at times at least about 3000 cP, at times at least about 4000 cP, at times at least about 5000 cP.

In some examples, the at least one hydrocolloid polymer is characterized by a viscosity of at least about 100 cP at 25° C., when dissolved in water, at a concentration of about 2% (w/v); at times of at least about 200 cP, at times at least about 300 cP, at times at least about 400 cP, at times at least about 500 cP, at times at least about 700 cP, at times at least about 800 cP, at times at least about 1000 cP, at times at least about 2000 cP, at times at least about 3000 cP, at times at least about 4000 cP, at times at least about 5000 cP.

In some examples, the at least one hydrocolloid polymer has a viscosity of at least 1,000 cP at 25° C., when dissolved in water, at a concentration of about 1% (w/v).

In some examples, the at least one hydrocolloid polymer has a viscosity of at least 1,000 cP at 25° C., when dissolved in water, at a concentration of about 2% (w/v).

In some examples, the at least one hydrocolloid polymer is characterized by a viscosity of at least about 10,000 cP at 25° C., when dissolved in water, at a concentration of about 2% (w/v); at times of at least about 20,000 cP, at times at least about 30,000 cP, at times at least about 40,000 cP, at times at least about 50,000 cP, at times at least about 70,000 cP, at times at least about 80,000 cP.

In some examples, the at least one hydrocolloid polymer is characterized by a viscosity at 25° C., of between about 100 cP and about 100,000 cP, at times between about 100 cP and about 80,000 cP, at times between about 100 cP and about 70,000 cP, at times between about 100 cP and about 60,000 cP, at times between about 100 cP and about 50,000 cP, at times between about 100 cP and about 40,000 cP, at times between about 100 cP and about 30,000 cP, at times between about 100 cP and about 20,000 cP, at times between about 100 cP and about 10,000 cP, at times between about 100 cP and about 8000 cP, at times between about 100 cP and about 6000 cP.

In some examples, the at least one hydrocolloid polymer is characterized by a viscosity at 25° C., of between about 300 cP and about 100,000 cP, at times between about 500 cP and about 100,000 cP, at times between about 1,000 cP and about 100,000 cP, at times between about 1,500 cP and about 100,000 cP, at times between about 2,000 cP and about 100,000 cP, at times between about 2,500 cP and about 100,000 cP, at times between about 3,000 cP and about 100,000 cP, at times between about 3,500 cP and about 100,000 cP, at times between about 4,000 cP and about 100,000 cP, at times between about 4500 cP and about 100,000 cP, at times between about 5000 cP and about 100,000 cP.

In some examples, the at least one hydrocolloid polymer is characterized by a viscosity at 25° C., of between about 100 cP and about 15,000 cP, at times between about 100 cP and about 12,000 cP, at times between about 100 cP and about 10,000 cP, at times between about 100 cP and about 8,000 cP, at times between about 100 cP and about 6,000 cP, at times between about 100 cP and about 4000 cP, at times between about 100 cP and about 2000 cP, at times between about 100 cP and about 1000 cP, at times between about 100 cP and about 800 cP, at times between about 100 cP and about 600 cP.

In some examples, the at least one hydrocolloid polymer is characterized by a viscosity at 25° C., of between about 300 cP and about 15,000 cP, at times between about 400 cP and about 15,000 cP, at times between about 500 cP and about 15,000 cP, at times between about 700 cP and about 15,000 cP, at times between about 900 cP and about 15,000 cP, at times between about 1000 cP and about 15,000 cP, at times between about 1200 cP and about 15,000 cP, at times between about 1500 cP and about 15,000 cP, at times between about 2000 cP and about 15,000 cP, at times between about 5000 cP and about 15,000 cP, at times between about 7000 cP and about 15,000 cP.

In some examples, the at least one hydrocolloid polymer is characterized by a viscosity at 25° C., of at least about 1,500 cP, or between about 1,500 cP and about 3,000 cP, at times between 1,000 cP and about 2,000 cP, when dissolved in water at a concentration of 1 wt %.

In some examples, the at least one hydrocolloid polymer is characterized by a viscosity at 25° C., of at least about 3,000 cP or between about 3,000 cP and about 5,000 cP, when dissolved in water at a concentration of 1 wt %.

In some examples, the at least one hydrocolloid polymer has a viscosity at 25° C., of at least about 10,000 cP, or about 15,000 cP, or between about 10,000 cP and about 15,000 cP, when dissolved in water at a concentration of 2 wt %.

In some embodiments, the at least one hydrocolloid polymer is in an amount of at least about 0.1% out of the total weight of the edible product, at times at least about 0.5%, at times at least about 1%, at times at least about 2%, at times at least about 3%, at times at least about 3.5%, at times at least about 4%, at times at least about 4.5%, at times at least about 5%, at times at least about 5.5%, at times at least about 6%, at times at least about 6.5%, at times at least about 7%, at times at least about 7.5%, at times at least about 8%, at times at least about 8.5%, at times at least about 9%, at times at least about 9.5%, at times at least about 10%, at times at least about 11%, at times at least about 12%, at times at least about 13%, at times at least about 14%, at times at least about 15%, at times at least about 16%, at times at least about 17%, at times at least about 18%, at times at least about 19%, at times at least about 20%, at times at least about 21%, at times at least about 22%, at times at least about 23%, at times at least about 24%, at times at least about 25%, at times at least about 26%, at times at least about 27%, at times at least about 28%, at times at least about 29%, at times at least about 30%, at times at least about 31%, at times at least about 35%, at times at least about 40%, at times at least about 45%, at times at least about 50%, at times at least about 55%, at times at least about 60% out of the total weight of the edible product.

In some embodiments, the at least one hydrocolloid polymer is in an amount of about 1% out of the total weight of the edible product, at times about 1.5, at times about 2%, at times about 2.5%, at times about 3%, at times about 3.5%, at times about 4%, at times about 4.5%, at times about 5%, at times about 5.5%, at times about 6%, at times about 6.5%, at times about 7%, at times about 7.5%, at times about 8%, at times about 8.5%, at times about 9%, at times about 9.5%, at times about 10%, at times about 11%, at times about 12%, at times about 13%, at times about 14%, at times about 15%, at times about 16%, at times about 17%, at times about 18%, at times about 19%, at times about 20%, at times about 21%, at times about 22%, at times about 23%, at times about 24%, at times about 25%, at times about 26%, at times about 27%, at times about 28%, at times about 29%, at times about 30%, at times about 31%, at times about 35%, at times about 40%, at times about 45%, at times about 50%, at times about 55%, at times about 60%, at times about 65%, at times about 70% out of the total weight of the edible product.

In some embodiments, the at least one hydrocolloid polymer is in an amount of between about 0.1% and about 80% out of the total weight of the edible product, at times between about 0.1% and about 70%, at times between about 0.1% and about 60%, at times between about 0.1% and about 50%, at times between about 0.1% and about 40%, at times between about 0.5% and about 40%, at times between about 1% and about 35%, between about 1% and about 30% out of the total weight of the edible product.

In some embodiments, the at least one hydrocolloid polymer is in an amount of between about 0.1% and about 20% out of the total weight of the edible product, at times between about 0.5% and about 15%, at times between about 1% and about 20%, between about 1% and about 15% out of the total weight of the edible product.

In some embodiments, the at least one hydrocolloid polymer is in an amount of between about 3% and about 40% out of the total weight of the edible product, at times between about 3% and about 35%, at times between about 3% and about 30%, at times between about 3% and about 25%, at times between about 4% and about 25%, at times between about 5% and about 25%, between about 6% and about 25%, between about 7% and about 25%, between about 8% and about 25%, between about 9% and about 25% out of the total weight of the edible product.

In some embodiments, the at least one hydrocolloid polymer is in an amount of between about 3% and about 20% out of the total weight of the edible product, at times between about 3% and about 15%, at times between about 3% and about 20%, between about 3% and about 15% out of the total weight of the edible product.

In some embodiments, the at least one hydrocolloid polymer is in an amount of between about 9.5% and about 25% out of the total weight of the edible product, at times between about 10% and about 25%, at times between about 11% and about 25%, between about 12% and about 25%, between about 15% and about 25% out of the total weight of the edible product.

As noted herein, the at least one hydrocolloid polymer comprises at least one film forming polymer.

As used herein, the term “film forming polymer” is any molecule that can be used to allow forming a film and optionally allowing the film to form a matrix structure (in such case may be denoted as film forming matrix component).

In some examples, the at least one film forming polymer is or comprises a polysaccharide.

In some examples, the polysaccharide is at least one polyelectrolyte.

In some embodiments, the polysaccharide is a linear polysaccharide, a branched polysaccharide or a combination thereof. In some embodiments, the polysaccharide is a linear polysaccharide. In some embodiments, the polysaccharide is a branched polysaccharide.

In some embodiments, the polysaccharide is an anionic polysaccharide.

In some embodiments, the polysaccharides is a homo-polysaccharide, a hetero-polysaccharide or a combination thereof. In some embodiments, the polysaccharides is a homo-polysaccharide. In some embodiments, the polysaccharides is a hetero-polysaccharide.

In some embodiments, the polysaccharides is any one of at least one of a storage polysaccharide or at least one of a structural polysaccharide.

The polysaccharide can be in accordance with the present disclosure can be a polysaccharide from any source and include any one of at least one native polysaccharide, at least one modified polysaccharide, at least one hydrolysate polysaccharide or any combination thereof.

In some embodiments, the polysaccharide is any one of at least one cellulose and/or at least one starch and/or at least one chitin, and/or at least one of arabinoxylan and/or at least one of pectin.

In some embodiments, the polysaccharide is at least one cellulose and derivative thereof. In some other embodiments, the polysaccharide is at least one starch. In some embodiments, the polysaccharide is at least one chitin. In some embodiments, the polysaccharide is at least one arabinoxylan. In some embodiments, the polysaccharide is at least one pectin.

In some embodiments, the polysaccharide is at least one of alginate, carrageenan, methylcellulose (MC), hydroxypropylmethylcellulose (HPMC), hydroxyproplylcellulose, carboxymethylcellulose (CMC), gum arabic, chitosan, pectin, guar gum, agar, gellan gum, gum karaya, gum tragacanth, konjac mannan, locust beam gum, xanthan gum, starch or any combination thereof.

In some examples, the polysaccharide comprises at least one fiber.

In some examples, the polysaccharide comprises at least one cellulose, chitin, lignin, xanthan gum, starch, arabinoxylan, fructans, inulin, pectin, alginate, agar, carrageenan, polydextrose.

The fibers may be from any source including, inter alia, a fruit, a vegetable, a cereal, a legume or algae.

In some examples, the polysaccharide is or comprises a cellulose.

In the context of the present disclosure, the term “cellulose” is used to denote natural cellulose as well as cellulose derivatives. In some examples, the polymer comprises one or more cellulose derivatives.

Cellulose derivatives are typically cellulose ether derivatives or cellulose ester derivatives, the latter typically being water insoluble. Thus, in the context of the present disclosure, when referring to cellulose derivatives it is to be understood to encompass cellulose ether derivatives. These include, without being limited thereto, Methyl cellulose (MC), Ethyl cellulose (EC), Hydroxyethyl cellulose (HEC), Hydroxypropyl cellulose (HPC), hydroxypropylmethyl cellulose (HPMC), carboxymethyl cellulose (CMC) and sodium carboxymethyl cellulose (NaCMC).

In some examples, the polymer comprises at least methyl cellulose (MC).

In some examples, the polymer comprises at least hydroxypropyl methyl cellulose (HPMC).

In some examples, the polymer comprises at least xanthan gum.

In some examples, the polymer comprises at least guar gum.

In some examples, the polymer comprises at least carboxymethylcellulose (CMC).

In some examples, the polymer comprises one or more polymers selected from the group consisting of methyl cellulose, hydroxypropylmethylcellulose, xanthan gum, guar gum, carboxymethylcellulose and any combination of same.

In some examples, the edible product comprises a combination of two polymers, at times a combination of three polymers, at times four polymers, at times five polymer and at times even six or more polymers. In some examples, the edible product comprises a combination of two polymers.

In some examples, the edible product comprises a combination of combination of MC and HPMC.

In some examples, the edible product comprises a combination of combination of MC and CMC.

In some examples, the edible product comprises a combination of combination of CMC and HPMC.

In some examples, the edible product comprises a combination of combination of MC, CMC and HPMC.

In some embodiments, the at least one film forming polymer is in an amount of at least about 1% out of the total weight of the edible product, at times at least about 1.5, at times at least about 2%, at times at least about 2.5%, at times at least about 3%, at times at least about 3.5%, at times at least about 4%, at times at least about 4.5%, at times at least about 5%, at times at least about 5.5%, at times at least about 6%, at times at least about 6.5%, at times at least about 7%, at times at least about 7.5%, at times at least about 8%, at times at least about 8.5%, at times at least about 9%, at times at least about 9.5%, at times at least about 10%, at times at least about 11%, at times at least about 12%, at times at least about 13%, at times at least about 14%, at times at least about 15%, at times at least about 16%, at times at least about 17%, at times at least about 18%, at times at least about 19%, at times at least about 20%, at times at least about 21%, at times at least about 22%, at times at least about 23%, at times at least about 24%, at times at least about 25%, at times at least about 26%, at times at least about 27%, at times at least about 28%, at times at least about 29%, at times at least about 30%, at times at least about 31%, at times at least about 35%, at times at least about 40%, at times at least about 45%, at times at least about 50%, at times at least about 55%, at times at least about 60% out of the total weight of the edible product.

In some embodiments, the at least one film forming polymer is in an amount of about 1% out of the total weight of the edible product, at times about 1.5, at times about 2%, at times about 2.5%, at times about 3%, at times about 3.5%, at times about 4%, at times about 4.5%, at times about 5%, at times about 5.5%, at times about 6%, at times about 6.5%, at times about 7%, at times about 7.5%, at times about 8%, at times about 8.5%, at times about 9%, at times about 9.5%, at times about 10%, at times about 11%, at times about 12%, at times about 13%, at times about 14%, at times about 15%, at times about 16%, at times about 17%, at times about 18%, at times about 19%, at times about 20%, at times about 21%, at times about 22%, at times about 23%, at times about 24%, at times about 25%, at times about 26%, at times about 27%, at times about 28%, at times about 29%, at times about 30%, at times about 31%, at times about 35%, at times about 40%, at times about 45%, at times about 50%, at times about 55%, at times about 60% out of the total weight of the edible product.

In some embodiments, the at least one film forming polymer is in an amount of between about 0.8% and about 80% out of the total weight of the edible product, at times between about 1% and about 70%, at times between about 1% and about 60%, at times between about 1% and about 50%, at times between about 1% and about 45%, at times between about 1% and about 40%, at times between about 1% and about 35%, at times between about 1% and about 30%, at times between about 1% and about 25%, at times between about 1% and about 20%, at times between about 1% and about 15%, at times between about 1% and about 10%, between about 1% and about 8% out of the total weight of the edible product.

In some embodiments, the at least one film forming polymer is in an amount of between about 1% and about 55% out of the total weight of the edible product, at times between about 2% and about 45%, at times between about 2% and about 35%, at times between about 2% and about 30%, at times between about 2% and about 25%, at times between about 5% and about 25%, between about 6% and about 25%, between about 7% and about 25%, between about 8% and about 25%, between about 9% and about 25% out of the total weight of the edible product.

In some embodiments, the at least one film forming polymer is in an amount of between about 9.5% and about 25% out of the total weight of the edible product, at times between about 10% and about 25%, at times between about 11% and about 25%, between about 12% and about 25%, between about 15% and about 25% out of the total weight of the edible product.

In some examples, the at least one film forming polymer being in a total amount of at least about 0.1 wt %, at times at least about 0.5%, at times at least about 1%, at times at least about 2%, at times at least about 5%, at times at least about 10%, at times at least about 20%, at times at least about 30%, at times at least about 40%, at times at least about 50%, at times at least about 60%, at times at least about 70%, at times at least about 80%, at times at least about 90%, at times at least about 95%, at times at least about 99%, out of the total amount (wt %) of the hydrocolloid polymer.

In some examples, the at least one film forming polymer being in a total amount of about 0.1 wt %, at times about 0.5%, at times about 1%, at times about 2%, at times about 4%, at times about 5%, at times about 10%, at times about 20%, at times about 30%, at times about 40%, at times about 50%, at times about 60%, at times about 70%, at times about 80%, at times about 90%, at times about 95%, at times about 99%, at times about 100% out of the total amount (wt %) of the hydrocolloid polymer.

In some examples, the at least one film forming polymer being in a total amount of between about 0.1 wt % and about 100%, at times between about 0.5% and about 100%, at times between about 2% and about 100%, at times between about 4% and about 100%, at times between about 10% and about 100%, at times between about 10% and about 100%, at times between about 20% and about 100%, at times between about 30% and about 100%, out of the total amount (wt %) of the hydrocolloid polymer.

As described herein, the edible product comprises at least one protein. The present disclosure is not limited to a specific type of protein and is applicable to any edible protein. For example, an edible protein that it's flavor profile should be improved.

In some examples, the protein is selected from the group consisting of beta-gonglycinin, glycinin, vicilin, legumin, albumins, globulins, glutelins, gluten, gliadins, glutenins, mycoproteins.

In some examples, the protein is derived from a microorganism, the microorganism selected from algae, fungi, bacteria.

In some examples, the protein is or comprises a recombinantly produced protein. In some examples, the recombinantly produced protein is selected from the group consisting of casein, whey protein, lactoglobulin, gelatin, hemoglobin, collagen, albumin.

In some examples, the protein is from an animal source. In some examples, the protein from an animal source is at least one of (i) at least one meat protein, (ii) at least one seafood protein, (iii) at least one dairy protein, (iv) at least one egg protein, (v) at least one poultry protein, (vi) at least one beef protein or (vii) any combination thereof.

In some examples, the at least one meat protein is a protein from beef, chicken, pork, lamb or any combination thereof.

In some examples, the at least one seafood protein is a protein from fish, shrimp, crab, lobster or any combination thereof.

In some examples, the at least one diary protein is a protein from milk, cheese, yogurt or any combination thereof.

In some examples, the at least one protein is from eggs.

In some examples, the at least one diary protein is from beef.

In some examples, the protein is a plant protein. When referring to “plant protein” it is to be understood to encompass any protein that is extracted from a plant part.

The extracted protein material can be a protein isolate, i.e. including at least 90% protein material and 10% components from the plant that are non-proteinous (fibers, lipids/fat, carbohydrates, ash etc); the extracted protein material can be a protein concentrate, i.e. including about 70% or more protein material and up to 30% components from the plant that are non-proteinous. Alternatively, the protein material may be a plant flour comprising the plant protein. As times, the plant flour may comprise about 5%, about 10%, about 15% or about 20% or more of the protein.

It should be noted that the plant derived protein may be in a form of a plant concentrate or plant isolate. A plant concentrate or plant isolate, may include in addition to the plant protein per se additional components.

The plant derived protein can be obtained from various plants. It can include protein from a single plant or from different plants, namely, protein from different plant sources.

In some examples, the plant is selected from the group consisting of soy, wheat, legume, lentil, lupin, mung bean, navy bean, peanut, sunflower, almond, corn, oat, potato, quinoa, rice, sorghum, seitan, seeds of sort-chia, hemp, beans of sort-edamame bean, black bean, kidney bean, nuts of sort-cashews, pistachios, walnut, hazelnuts, flax.

In some examples, the protein is selected from the group consisting of soy protein, pea protein, chickpea protein, lupine protein, mung-bean protein, kidney bean protein, black bean protein, alfalfa protein, almond protein, and any combination of same.

In some examples, the plant is legume, i.e. the protein is legume protein, preferably at least chickpea protein.

In some examples, the plant protein comprises a combination of at least pea protein and chickpea protein.

In some embodiments, the plant protein is an almond protein.

In some examples, the plant protein comprises a at least pea protein.

In some examples, the plant protein is from whole grain.

In some examples, the at least one whole grain protein is a protein from quinoa, brown rice, whole wheat or any combination thereof.

In some examples, the at least one protein is from spirulina.

The amount of the at least one protein in the edible product may vary depending on various factors, such as it's use and manner of use.

In some examples, the edible product comprises at least about 1% protein, at times at least 2%, at times at least 3%, at times at least 4%, at times at least 5%, at times at least 6%, at times at least 7%, at times at least 8%, at times at least 9%, at times at least 10%, at times at least 11%, at times at least 12%, at times at least 13%, at times at least 14%, at times at least 15%, at times at least 16% protein of the total weight of the edible product.

In some examples, the edible product comprises between about 1% and about 99% protein, at times between about 5% and about 99%, at times about 10% and about 99%, at times between about 15% and about 99%, at times between about 20% and about 99%, at times between about 25% and about 99%, at times between about 30% and about 99%, at times between about 35% and about 99%, at times between about 40% and about 99%, at times between about 45% and about 99%, at times between about 50% and about 99%, at times between about 55% and about 99%, at times between about 60% and about 99%, at times between about 65% and about 99%, at times between about 70% and about 99%, at times between about 75% and about 99% of the total weight of the edible product.

In some examples, the edible product comprises between about 1% and about 95% protein, at times between about 5% and about 90%, at times about 5% and about 85%, at times between about 5% and about 80%, at times between about 5% and about 75%, at times between about 5% and about 70%, at times between about 5% and about 65%, at times between about 5% and about 60%, at times between about 5% and about 55%, at times between about 5% and about 50%, at times between about 5% and about 45%, at times between about 5% and about 40%, at times between about 5% and about 35%, at times between about 5% and about 30% of the total weight of the edible product.

In some examples, the edible product comprises about 5% protein, at times about 10%, at times about 15%, at times about 20%, at times about 25%, at times about 30%, at times about 35%, at times about 40%, at times about 45%, at times about 50%, at times about 55%, at times about 60%, at times about 65%, at times about 70%, at times about 75%, at times about 80%, at times about 85%, at times about 90% out of the total weight of the edible product.

In some examples, the edible product comprises about 20% protein out of the total weight of the edible product. In some examples, the edible product comprises about 55% protein out of the total weight of the edible product. In some examples, the edible product comprises about 80% protein out of the total weight of the edible product.

The edible product may be free or having low amounts of a flavor masking agent. As appreciated, a flavor masking agent is at times a food additive known to mask a certain flavor in food products. Hence, it was suggested that the improved flavor profile of the food product is achieved without addition of a making agent.

In some embodiments, the edible product comprises at least one animal protein and at least one hydrocolloid polymer.

In some embodiments, the edible product comprises at least one animal protein and at least one cellulose polymer.

In some examples, the edible product comprises at least one animal protein and at least MC.

In some examples, the edible product comprises at least one animal protein and at least MC and HPMC.

In some examples, the edible product comprises at least one animal protein and at least HPMC.

In some embodiments, the edible product comprises at least one plant protein and at least one hydrocolloid polymer.

In some embodiments, the edible product comprises at least one plant protein and at least one cellulose polymer.

In some examples, the edible product comprises at least one plant protein and at least one cellulose polymer. In some examples, the edible product comprises at least plant protein and at least MC. In some examples, the edible product comprises at least pea protein and at least cellulose polymer. In some examples, the edible product comprises at least pea protein and at least MC.

In some examples, the edible product comprises at least one plant protein and at least one cellulose polymer. In some examples, the edible product comprises at least plant protein and at least HPMC. In some examples, the edible product comprises at least pea protein and at least cellulose polymer. In some examples, the edible product comprises at least pea protein and at least HPMC.

In some examples, the edible product comprises at least one plant protein and at least one cellulose polymer. In some examples, the edible product comprises at least plant protein and at least one of MC, CMC and HPMC. In some examples, the edible product comprises at least pea protein and at least cellulose polymer. In some examples, the edible product comprises at least pea protein and at least one of MC, CMC and HPMC. In some examples, the edible product comprises at least a lentil protein and at least one of MC, CMC and HPMC. In some examples, the edible product comprises at least chickpea protein and at least one of MC, CMC and HPMC.

As described herein, in some examples, the edible product comprises at least one lipid.

In the context of the present disclosure the term lipid encompasses fats and oils.

In some examples, the lipid comprises plant derived oil. There are different plant derived oils that are acceptable in the food industry. The selection of the oil to be used can be based on the physical state at room temperature, e.g. solid, semi solid, liquid, on the organoleptic properties of the oil, and other considerations.

The lipid can be any one of combination of short-chain triglycerides, medium-chain triglycerides, long-chain triglycerides, sunflower oil, corn oil, palm oil, olive oil, canola oil, coconut oil, avocado oil, sesame oil, hydrogenated castor oil, hydrogenated castor oil derivatives, polyethylene glycols, citrate esters, phthalate esters, glyceryl esters, triacetin, glyceryl stearate, glyceryl behenate, dibutyl sebacate, aliphatic alcohols, fatty acids, sorbitan derivatives.

In some examples, the plant derived oil is selected from the group consisting of canola oil, coconut oil, corn oil, olive oil, sunflower oil, soybean oil, sesame oil, and any derivatives and combination of same.

In some examples, the plant derived oil comprises or is canola oil.

In some examples, the plant derived oil comprises or is coconut oil.

In some examples, the plant derived oil comprises a combination of at least canola oil and coconut oil. In some examples, when containing canola oil and coconut oil, the ratio between the two is essentially 1:1±10%.

In some examples, the lipid comprises triglycerides, typically medium chain triglycerides (MCT). When referring to MCT it is to be understood to encompass 6-12 carbon fatty acids and can include any one or combination of caprylic acid and capric acid. MCT can be obtained from plant, e.g. coconut oil, palm kernel oils or can be man mad or partially man mad. In the context of the present disclosure, any type of animal free MCT can be used.

In some examples, the edible product comprises at least one animal protein, at least one cellulose polymer and at least one lipid. In some examples, the edible product comprises at least animal protein, at least MC and at least one lipid. In some examples, the edible product comprises at least animal protein, at least HPMC and at least one lipid. In some examples, the edible product comprises at least animal protein, at least MC and HPMC and at least one lipid. In some examples, the edible product comprises at least one animal protein, at least cellulose polymer and at least canola oil. In some examples, the edible product comprises at least animal protein, at least cellulose polymer and at least canola oil. In some examples, the edible product comprises at least animal protein, at least MC and at least canola oil. In some examples, the edible product comprises at least animal protein, at least HPMC and at least canola oil. In some examples, the edible product comprises at least animal protein, at least MC and HPMC and at least canola oil.

In some examples, the edible product comprises at least one plant protein, at least one cellulose polymer and at least one lipid. In some examples, the edible product comprises at least pea protein, at least cellulose polymer and at least one lipid. In some examples, the edible product comprises at least plant protein, at least MC and at least one lipid. In some examples, the edible product comprises at least plant protein, at least HPMC and at least one lipid. In some examples, the edible product comprises at least plant protein, at least MC and HPMC and at least one lipid. In some examples, the edible product comprises at least one plant protein, at least cellulose polymer and at least canola oil. In some examples, the edible product comprises at least pea protein, at least cellulose polymer and at least canola oil. In some examples, the edible product comprises at least pea protein, at least MC and at least canola oil. In some examples, the edible product comprises at least pea protein, at least HPMC and at least canola oil. In some examples, the edible product comprises at least pea protein, at least MC and HPMC and at least canola oil.

The edible product may comprise in accordance with some examples at least one emulsifier. In some embodiments, the emulsifier comprises lecithin. In some embodiments, the lecithin is selected from the group consisting of sunflower lecithin and soy lecithin.

As noted above, it was surprisingly found that mixing the at least one protein and the at least one polymer as described herein provides an edible product with improved properties.

In accordance with some aspects, the present disclosure provides a method of improving flavor profile of a protein, the method comprises forming a film from an composition comprising at least one protein and at least one polymer, wherein the at least one polymer is or comprises at least one medium molecular weight polymer and/or high molecular weight polymer and wherein the flavor profile of the film is improved compared to the flavor profile of the protein.

In some examples, the composition comprising the at least one protein and the at least one polymer is an aqueous/solvent/mixture.

In accordance with some aspects, the present disclosure provides a method of improving flavor profile of a protein, the method comprises providing a composition comprising at least one protein and at least one polymer and forming a film from the composition, wherein the at least one polymer is or comprises at least one medium molecular weight polymer and/or high molecular weight polymer and wherein the flavor profile of the film is improved compared to the flavor profile of the protein.

In accordance with some aspects, the present disclosure provides a method of maintaining nutritional value of a protein, the method comprises forming a film from a composition comprising at least one protein and at least one polymer, wherein the at least one polymer is or comprises at least one medium molecular weight polymer and/or high molecular weight polymer and wherein the nutritional value of the film is substantially the same as compared to the nutritional value of the protein.

In accordance with some aspects, the present disclosure provides a method of maintaining nutritional value of a protein, the method comprises providing a composition comprising at least one protein and at least one polymer and forming a film from the composition, wherein the at least one polymer is or comprises at least one medium molecular weight polymer and/or high molecular weight polymer and wherein the nutritional value of the film is substantially the same as compared to the nutritional value of the protein.

Without being bound by theory, it was suggested that the methods of the present disclosure uniquely maintain the nutritional value of the protein, since these methods apply low shear force and low temperatures. This in comparison to other protein processing technologies.

In some examples, the method comprises at least partially drying the film to form an edible dry film.

The drying conditions are selected to allow formation of a film. In some examples, the film may be a continuous film.

In some examples, the method comprises at least partially drying of the film by exposing the film to a controlled heat. The at least partially drying of the film can be by any one or combination of heating the film within an oven, exposing the film to drying air, exposing the film to infrared (IR) radiation, heating within a microwave or direct heating (such as heating drum or plate).

In some examples, the at least partially drying of the film is until water content within the film is between about 0% and about 90%, between about 20% and about 90%, at times between about 25% and about 80%, at times between about 40% and about 80%; at times between about 40% and about 70% at times between about 40% and about 60%.

In some examples, the at least partially drying of the film is until water content within the film is between about 0.5% and about 5%, at times between about 0.5% and about 4%, at times between about 1% and abut 3%, at times between about 1% and 2%. In some examples, the at least partially drying of the film is until water content within the film is about 1%, at times about 1.5%, at times about 2%. It should be noted that such a film may be milled to obtain a powder (food ingredient).

In some embodiments, the at least partially drying of the film is at a temperature of at least about 60° C., at least about 70° C., at least about 80° C., at least about 90° C.

In some embodiments, the at least partially drying of the film is at a temperature of between about 60° C. and about 100° C., at times between about 70° C., and about 100° C.

In some embodiments, the at least partially drying of the film is at a temperature of about 60° C., about 65° C., about 70° C., about 80° C., about 90° C., about 95° C.

In some embodiments, the at least partially drying of the film is for at least about 1 second, at least about 2 seconds, at times at least about 5 seconds, at times at least about 20 seconds, at times at least about 40 seconds, at times at least about 1 minute, at times at least about 3 minutes, at times at least about 5 minutes, at least about 10 minutes, at least about 15 minutes, at least about 20 minutes, at least about 25 minutes, at least about 30 minutes.

In some embodiments, the at least partially drying of the film is for about 5 minutes, about 10 minutes, about 15 minutes, about 20 minutes, about 25 minutes, about 30 minutes, about 35 minutes, about 40 minutes.

In some examples, the at least partially drying of the film is at a temperature of about 65° C. for about 30 minutes.

In some examples, the at least partially drying of the film is at a temperature of about 70° C. for about 30 seconds, at times for about 40 seconds, at times for about 50 seconds, at times for about 60 seconds, at times for about 70 seconds, at times for about 80 seconds, at times for about 90 seconds, at times for about 100 seconds, at times for about 120 seconds.

In some examples, the at least partially drying of the film is at a temperature of about 70° C. for about 5 minutes, at times for about 20 minutes, at time for about 25 minutes, at times for about 30 minutes, at times for about 50 minutes.

In some examples, the method comprises subjecting the edible dry film to a size reduction method to obtain a dry powder. This includes any one or combination of crushing, grinding and milling.

In some embodiments, the method comprises subjecting the edible dry film to at least one size reduction step.

The milling (grinding/crushing) can be done by any conventional technique known in the food industry without damaging the protein quality.

In some examples, the method comprises milling the edible dry file to obtain an edible product in a powder form. In some examples, the powder form comprises particles have an average size/diameter of between about 1 mm and about 5 mm.

As noted herein, the edible product comprises in addition to the at least one protein and the at least one polymer also at least one lipid.

Hence, in accordance with some other aspects, the present disclosure provides a method of improving flavor profile of a protein, the method comprises forming a film from an emulsion composition comprising at least one protein, at least one polymer and at least one lipid, wherein the at least one polymer is or comprises at least one medium molecular weight polymer and/or high molecular weight polymer and wherein the flavor profile of the film is improved compared to the flavor profile of the protein.

In accordance with some other aspects, the present disclosure provides a method of maintaining nutritional value of a protein, the method comprises forming a film from an emulsion composition comprising at least one protein, at least one polymer and at least one lipid, wherein the at least one polymer is or comprises at least one medium molecular weight polymer and/or high molecular weight polymer and wherein the nutritional value profile of the film is substantially the same as compared to the nutritional value of the protein.

In accordance with some aspects, the present disclosure provides a method of improving flavor profile of a protein, the method comprises providing an emulsion composition comprising at least one protein, at least one polymer and at least one lipid and forming a film from the emulsion composition, wherein the at least one polymer is or comprises at least one medium molecular weight polymer and/or high molecular weight polymer and wherein the flavor profile of the film is improved compared to the flavor profile of the protein.

In accordance with some aspects, the present disclosure provides a method of maintaining nutritional value of a protein, the method comprises providing an emulsion composition comprising at least one protein, at least one polymer and at least one lipid and forming a film from the emulsion composition, wherein the at least one polymer is or comprises at least one medium molecular weight polymer and/or high molecular weight polymer and wherein the nutritional value of the film is substantially the same as compared to the nutritional value of the protein.

The edible product described herein is not limited to a specific product and may encompass a diverse food product.

The present disclosure may be applicable for protein enriched products.

In some examples, the edible product may be a meat alternative.

In some examples, the edible product is one or more of a plant-based chicken meat analogue product, a plant-based ham analogue product, a plant-based bacon analogue product, a plant-based cheese analogue product, a plant-based salmon meat analogue product, a plant-based yellow cheese analogue product, a plant-based hard cheese analogue product.

In some examples, the edible product is an energy bar. In some embodiments, the edible product is spreadable. In some examples, the spreadable is a mayonnaise-like, coconut-like.

In some examples, the edible product is a baked product. In some examples, the baked product is a cookie, a cake.

In some examples, the edible product does not require addition of water, for example, high amount of water in its preparation.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

It should be noted that various embodiments of this invention may be presented in a range format. The description of a range should be considered to have specifically disclosed all the possible sub ranges as well as individual numerical values within that range. For example, description of a range such as from 1 to 6 or between 1 and 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

As used herein, the forms “a”, “an” and “the” include singular as well as plural references unless the context clearly dictates otherwise. For example, the term “a polymer” or “a protein” includes one or more polymers or one or more proteins, respectively, which can form part of the edible product.

Further, as used herein, the term “comprising” is intended to mean that the composition include the recited components, e.g. hydrocolloid polymers, protein, lipids, water but not excluding other components, such as flavoring agents, colorants, etc.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

It should be noted that the various embodiments and examples detailed herein in connection with various aspects of the invention may be applicable to one or more aspects disclosed herein. It should be further noted that any embodiment described herein may be applied separately or in various combinations. Various embodiments and aspects of the present invention as delineated hereinabove and as claimed in the claims section below find experimental support in the following examples. The phrases “in another embodiment” or any reference made to the embodiment as used herein do not necessarily refer to a different embodiment, although it may. Thus, various embodiments of the invention can be combined (from the same or from different aspects) without departing from the scope of the invention.

Various embodiments and aspects of the present invention as delineated herein above and as claimed in the claims section below find experimental support in the following examples.

Disclosed and described, it is to be understood that this invention is not limited to the food ingredient, formulations, food products, methods disclosed herein as such food ingredients, formulations, food products, methods may vary somewhat. It is also to be understood that the terminology used herein is used for the purpose of describing particular embodiments only and not intended to be limiting since the scope of the present invention will be limited only by the appended claims and equivalents thereof.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### NON-LIMITING EXAMPLES

### Example 1: Characterization of Plant-Based Protein-Polymer Powders

Two powders with equal amounts of pea protein and methylcellulose (MC) were prepared using two different methods. The first method included a step of forming a film and grinding the film to obtain a powder whereas the second method include a step of mixing the components to obtain a powder. The two powers were characterized for their taste properties.

### Example 1A: Preparation of Protein and Polymer Powder from Film

The preparation of an exemplary plant-based/polymer edible product (food ingredient) in a form of a powder is provided below.

### Materials and Methods

A formulation was prepared including the components listed in Table 1A as detailed below.

TABLE 1A
Components of pea protein/polymer powder (“Formulation A”)

| Component | % Per batch | Dry weight % |
|---|---|---|
| Water | 59.56 | |
| MC Benecel ™ A4M MC | 5.20 | 12.86 |
| (Ashland) | | |
| Pea Protein (90% protein | 35.24 | 87.814 |
| Isolate) (LDC) | | |
| Total | 100.0% | |

Water was heated to 70° C. degrees using a Thermomix, and dried MC and pea protein powder were added and vigorously mixed for 5 minutes at 45° C. The emulsion was transferred to a mixer for cooling and then refrigerated until drying.

The chilled emulsion was applied to 1000-micron frames to create a thin film and dried in a drying oven at 80° C. for 3 hours.

The film was dried completely to a moisture content of <5% using a moisture content analysis (Mettler Toledo). The dried film was pulverized in a kitchen spice grinder to create a fine powder and stored in a sealed box until the tasting test.

### Example 1B: Preparation of Protein and Polymer Powder by Mixing

The preparation of an exemplary plant-based/polymer edible product (food ingredient) in a form of a powder is provided below.

### Materials and Methods

A formulation was prepared including the components listed in Table 1B as detailed below.

TABLE 1B
Components of pea protein/polymer powder (“Formulation B”)

| | Dry weight |
|---|---|
| Component | % |
| MC Benecel ™ A4M MC (Ashland) | 12.86 |
| Pea Protein Isolate (LDC) | 87.814 |

All of the dried ingredients (protein and MC) were thoroughly hand-mixed and kept in a sealed box until the tasting.

### Example 1C: Taste Characterization of the Powders

### Tasting Test Method:

Eleven tasters were given the two powders in a blind tasting. Tasters were asked about organoleptic traits: General taste intensity, protein taste intensity, and aroma intensity and graded each parameter for each powder on a 1-10 scale.

Each taster drank a glass of water and was then given a spoonful of each powder before filling out the tasting test questionnaire. After additional drinking of water, the second powder was tasted. Results were summarized in MS Excel and using a standard t-test to assess the significant of the results.

### Results:

The results of the taste study are shown in FIG. 1.

As can be seen from FIG. 1, the protein/polymer powder that was prepared by grinding a film was characterized by a significantly lower protein intensity (3.73) as compared to the protein intensity (7.73) of a protein/polymer powder having the same components but prepared by mixing the dried components.

In addition, as shown in FIG. 1, the protein/polymer powder that was prepared by grinding a film was characterized by a lower aroma intensity (2.82) and lower taste intensity (4.09) as compared to the aroma intensity (4.36) and taste intensity (7.09) of a protein/polymer powder having the same components but prepared by mixing the dried components. These results show that the protein taste characteristics are improved in the powder formed by the method that comprises film preparation. It was suggested that the film reduced the protein taste and hence unwanted protein off notes are masked.

### Example 2: Plant-Based Protein and Polymer Mixtures

### Example 2A: Protein and Polymer Mixtures Prepared by Dry Mixing Process

The preparation of a plant-based edible product (food ingredient) is provided below.

### Materials and Methods

A mixture composition was prepared including the components of Table 2A:

TABLE 2A
Plant-based protein mixture composition (batch size 450 g)

| | Amount per batch |
|---|---|
| Component | (g) |
| Pea protein Isolate (90% protein content) (LDC) | 410 |
| Benecel ™ Methyl cellulose A4M (Ashland) | 34 |
| Hydroxypropyl methyl cellulose (HPMC) K15M | 6 |
| (Ashland) | |
| Total | 450 |

Specifically, pea protein, methylcellulose, hydroxypropyl methylcellulose, were weighed and added to a V shape blender and mixed for 15 minutes.

### Results:

The final dried product (edible product, food ingredient) was a mixture comprising pea protein and hydrocolloids having a composition shown in Table 2B.

The average moisture content of the final edible product was derived from the original moisture content of each ingredient.

The final mixture was characterized as having a strong pea protein taste.

TABLE 2B
Final mixture Dry basis

| | Amount per dry |
|---|---|
| Component | basis (%) |
| Pea protein Isolate (90% protein content) (LDC) | 91.2 |
| Benecel ™ Methyl cellulose A4M (Ashland) | 7.5 |
| Hydroxypropyl methyl cellulose (HPMC) K15M (Ashland) | 1.3 |
| Total | 100 |

### Example 2B: Pea Protein and Cellulose Mixtures Prepared by Wet Mixing

The preparation of a plant-based edible product is provided below.

### Materials and Methods

A mixture composition is prepared including the components of Table 2C:

TABLE 2C
Plant-based protein mixture composition (batch size 2450 g)

| Component | Amount per batch (g) |
|---|---|
| Water | 2000 |
| Pea protein Isolate (90% protein | 410 |
| content) (LDC) | |
| Benecel ™ Methyl cellulose A4M | 34 |
| (Ashland) | |
| Hydroxypropyl methyl cellulose | 6 |
| (HPMC) K15M (Ashland) | |
| Total | 450 |

Water, methylcellulose, and hydroxypropyl methylcellulose, are weighed and added to a mixing vessel and mixed for 120 minutes to create a hydrocolloid solution. Pea protein is weighed and added to a V-shaped blender.

Then, the hydrocolloid solution is poured gradually into the V-shaped blender including the pea protein to create a homogenous mixture.

The mixture is dried in an oven for 5 hours at 90° C. The dried mixture is milled to obtain a uniform powder.

### Example 2C: Pea Protein and Cellulose Mixtures Prepared by Film Coating

The preparation of an exemplary plant-based ingredient (edible product) is provided below.

### Materials and Methods

A dispersion composition was prepared including the components of Table 2D:

TABLE 2D
Plant-based protein - dispersion composition (batch size 1650 g)

| Component | Amount per batch (g) |
|---|---|
| Water | 1200 |
| Pea protein Isolate (90% protein | 410 |
| content) (LDC) | |
| Benecel ™ Methyl cellulose A4M | 34 |
| (Ashland) | |
| Hydroxypropyl methyl cellulose | 6 |
| (HPMC) K15M (Ashland) | |
| Total | 1650 |

Water was added to a 4 L container and heated to about 70° C. Pea Protein Isolate was added to the preheated water and homogenized for about 10 minutes at 21.500 l/min. Methylcellulose and hydroxypropyl methylcellulose, were added, while homogenizing for 10 minutes.

The dispersion was transferred to a mixer and stirred at the lowest speed for about 2 hours allowing cooling to ambient temperature until a homogenous dispersion was obtained.

The dispersion was poured on a nonstick liner web, using a tabletop applicator with a 1000 μm gap. The dispersion was dried in an oven at 90° C. for about 50 minutes to obtain a film with a low moisture content, an image of which is provided in FIG. 2.

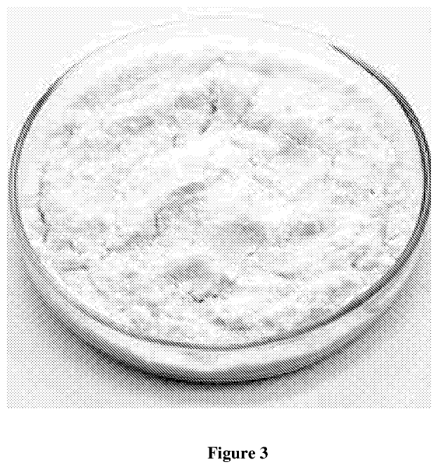

The film was milled using a standard high-shear grinder to achieve a homogenous powder, an image of which is provided in FIG. 3.

### Results:

The final dried product was a homogenous pea protein powder containing about 1.5% water, having the composition of Table 2E:

The final dried product was characterized as having a neutral taste or a lower beany taste than the reference.

TABLE 2E
Pea protein powder - Final Composition

| | Amount |
|---|---|
| | per dry |
| Component | basis (%) |
| Pea protein Isolate (90% protein content) (LDC) | 91.2 |
| Benecel ™ Methyl cellulose A4M (Ashland) | 7.5 |
| Hydroxypropyl methyl cellulose (HPMC) K15M | 1.3 |
| (Ashland) | |
| Total | 100 |

* The water amount was neglected in the calculation due to low water content (~1.5%).

Taken together, the results in these examples show that mixtures of pea protein (at high amounts) and polymers, hydrocolloid polymers such as MC and HPMC have different properties depending on the preparation process. Specifically, as shown in Example 2A, when pea protein and polymer were mixed and dried, the mixture had a strong pea protein taste, whereas as shown in Example 2C, when pea protein and polymer formed a homogenous film, the mixture in a form of a powder has a neutral taste. These results suggest that a power prepared from a film as described herein is highly advantage as the protein taste is reduced (masked).

### Example 3: Plant-Based Cheese Made from Pure Almonds

The preparation of an exemplary plant-based cheese is provided below.

### Materials and Methods

An emulsion composition was prepared including the components of Table 3A:

TABLE 3A
Plant-based cheese emulsion composition (batch size 970 g)

| Component | Amount per batch (g) |
|---|---|
| Water | 725 |
| Pure almond butter (23.6% protein content) | 212.7 |
| Benecel ™ Methylcellulose A4M (Ashland) | 8 |
| Sunflower Lecithin | 9 |
| Table Salt | 6.8 |
| Nutritional yeast | 9 |
| Total | 970 |

Specifically, water was added to a 4 L container and heated to about 70° C. Pure almond butter and Lecithin were added to the preheated water and homogenized for about 10 minutes at 21.500 l/min till homogenous emulsion was obtained. Salt and Nutritional yeast were added and homogenizing for 10 minutes.

Methylcellulose was added and homogenizing for 10 minutes.

The emulsion was transferred to a mixer and stirred at the lowest speed for about 2 hours to cool down to ambient temperature until a homogenous emulsion was obtained.

The emulsion was poured on a nonstick liner web, using a stainless-steel mold of 1500 μm. The emulsion was dried in an oven at 70° C. for about 20 minutes.

The layer was taken out from the oven and emulsion was poured on top of the layer using a stainless-steel mold of 1500 μm, the layers were dried in an oven at 70° C. for about 20 minutes.

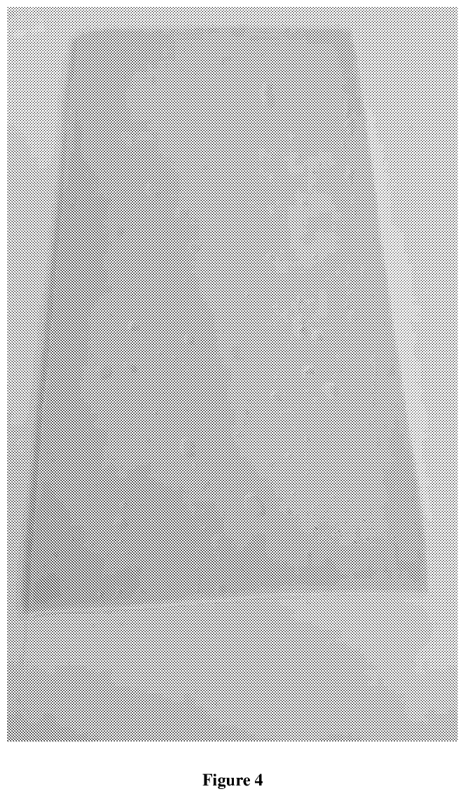

The layers were taken out from the oven and emulsion was poured on top of the layers using stainless steel mold 1000 μm. The emulsion was dried in an oven at 70° C. for about 20 minutes. Eventually, a Mozzarella like cheese was obtained, a picture of which is provided in FIG. 4. The plant base hard Mozzarella cheese was stored in a refrigerator at 4-8° C. over night.

### Results:

The final product was a plant-based Mozzarella hard cheese, 2500 μm thick, containing about 45% water and the composition of Table 3B:

TABLE 3B
Plant-based Mozzarella Hard Cheese - Final Composition

| Component | Amount per dry basis (%) |
|---|---|
| Water | 0 |
| Pure almond butter (23.6% protein content) | 86 |
| Benecel ™ Methylcellulose A4M (Ashland) | 3.3 |
| Sunflower Lecithin | 3.8 |
| Table Salt | 2.8 |
| Nutritional yeast | 3.8 |
| Total | 100 |

The organoleptic texture was similar to that of animal-based hard cheese with the ability to roll and band the product without immediate tearing.

### Example 4: Plant-Based Food Products

Gouda cheese and prosciutto were prepared using a Thermomix mixer, followed by shape film forming and drying to the target moisture content level of 50% as detailed in Tables 4A and 4B.

TABLE 4A
Plant-based Gauda cheese

| Component | Function | % per batch |
|---|---|---|
| Water | Water | 50.0 |
| Sunflower Lecithin | Emulsifier | 1.5 |
| Refined Canola oil | Oil | 10.7 |
| Refined coconut oil | Oil | 10.7 |
| Benecel ™ Methylcellulose A4M | Hydrocolloid | 2.6 |
| (Ashland) | | |
| Pea protein isolate (LDC) (87%) | Protein | 17.6 (net 15.3% |
| | | protein) |
| Salt (NaCl) | Flavor | 2.0 |
| Cheese flavor | Flavor | 2.8 |
| Yeast extract | Flavor | 0.3 |
| Citric Acid | Flavor | 0.3 |
| Calcium carbonate | Calcium source | 1.5 |
| Annatto color | Color | 0.0 |
| Total | | 100.0 |

For the preparation of the Plant-based Gouda, Water and lecithin were mixed in a Thermomix for 2 minutes. The oils were added and mixed for a further 10 minutes. After the oil-in-water emulsion was formed, the protein isolate was added to the emulsion and mixed at a medium speed for an additional 10 minutes. Yeast extract, Citric acid, Calcium carbonate, MC and salt mixed at maximum speed for an additional 10 minutes. The emulsion was transferred to a mixer and mixed for 60 minutes for cooling and additional mixing with the flavoring and coloring. The final mixture was stored in a refrigerator overnight. The product was layered in 3000 microns thickness stainless steel frame to create a fine film and dried in a MRC drying oven in the middle tray at 80 degrees for 30 minutes. The film was cut from the metal frame sealed in an airtight package and frozen until tasting.

TABLE 4B
Plant-based Prosciutto

| Component | Function | % per batch |
|---|---|---|
| Water | Water | 40.0 |
| Pea protein isolate LDC (87%) | Protein | 17.6 |
| Refined Canola oil | Oil | 17.7 |
| Bacon flavor | Flavor | 6.9 |
| Salt (NaCl) | Flavor | 3.2 |
| Sunflower Lecithin | Emulsifier | 3.0 |
| Benecel ™ Methylcellulose A4M | Hydrocolloid | 2.9 |
| (Ashland) | | |
| Citrus fibers | Fibers | 2.2 |
| Smoke flavor | Flavor | 1.4 |
| Hydroxy-propyl-methylcellulose | Hydrocolloid | 1.3 |
| (Ashland) | | |
| Color (Beetroot extract) | Color | 1.3 |
| Native tapioca starch | Hydrocolloid | 1.1 |
| Sugar (Sucrose) | Flavor | 0.8 |

For the preparation of the Plant-based Prosciutto, Water, Oil and lecithin were mixed in a Thermomix at max speed in room temperature for 10 minutes. After Oil in water emulsion was formed, Salt, protein powder, fibers, sugar, citric acid and starch were added to the emulsion and mixed at a medium speed for additional 10 minutes. The emulsion was heated to 55 degrees and mixed thoroughly, and the MC was tipped to the emulsion for 5 minutes mix. The emulsion was transferred to a mixer and mixed for 60 minutes for cooling and additional mixing with the flavoring and coloring. The final mixture was stored in a refrigerator overnight. The product was layered in 1000 microns thickness stainless steel frame to create a fine film and dried in a MRC drying oven in the middle tray at 70 degrees for 20 minutes. The film was cut from the metal frame and sealed in an airtight package and frozen until tasting. An emulsion as described in Table 4C was used as a control for the tasting test.

TABLE 4C
Components of an emulsion

| Component | Type | % per batch |
|---|---|---|
| Water | Water | 67.4 |
| Refined Canola oil | Oil | 15.0 |
| Pea protein isolate LDC (87%) | Protein | 17.6 |

For the preparation of the protein emulsion water at room temperature was weighed and canola oil was added to the bowl.

The mixture was homogenized with a lab disperser at 13500 RPM for 5 minutes. After an emulsion was formed, the protein was tipped and homogenized again at 13500 RPM for 5 minutes.

The emulsion was stored in a box and refrigerated.

### Tasting Experiments of the Plant-Based Products.

### Methods

The tasting experiment was a blind test in which the participants were not informed of the test's goal. The test included 30 participants at ages 17 to 70 both men and women with no specific tasting preferences regarding the product.

### Basic Plant Protein Taste Training

Before the tasting, basic training to identify the taste of the plant-based protein used in the tested products was conducted as follows:
a. The participants sipped water, ate a cucumber slice, and then sipped water again, in this order. This serves as a palate-cleaning stage before the basic training.
b. An emulsion composed of water, canola oil and the pea protein isolate (87%) was tasted by the participants, at least two sips each. The protein concentration in the training emulsion is similar to the protein concentrations in the products (an average of the protein concentrations in products). This was considered as a “calibration” tasting for the panel.
c. After the training emulsion tasting, the participants were told that the emulsion that they tasted was defined as “very strong protein taste (grade 10)”, according to the following scale and they should regard this as the maximum plant protein taste intensity in their next ranking:

TABLE 5
Ranking of tasters

| Very weak | | Weak | | Medium | | Strong | | Very strong | |
|---|---|---|---|---|---|---|---|---|---|
| 1 | 2 | 3 | 4 | 5 | 6 | 7 | 8 | 9 | 10 |

X

After the basic training, the participants had a resting period of 10 minutes, in which they sipped water, followed by eating a slice of cucumber, and finally, another sip of water—to cleanse the palate and prepare for the tasting of the products.

### Products Tasting

Two products, containing pea protein, were tasted: Gouda Cheese (formulation described in Table 4A) and Prosciutto (formulation described in Table 4B).

Each product was tasted, and the following attributes saltiness, sourness, flavor, aroma intensity, protein taste intensity and firmness were ranked between 1 to 10 as detailed above in Table 5, i.e. very weak 1, 2; weak 3, 4; medium 5, 6; strong 7, 8; very strong 9, 10.

Between product tastings, the participants cleansed their palate by sipping water, eating cucumber, and sipping water.

The whole tasting panel process took place in a well-lit room and a quiet environment. Participants were not allowed to discuss the test and results while tasting.

### Tasting Data Analysis

The collected data was analyzed using standard statistical methods (t-test, X2 test, etc.).

### Results and Discussion

The results for the Gouda cheese and prosciutto are shown in Table 6.

TABLE 6
Test results for Gauda cheese and prosciutto tasting panel

| | | | General | | | |
|---|---|---|---|---|---|---|
| | | | taste | Protein | Aroma | |
| | Saltiness | Sourness | intensity | intensity | intensity | Firmness |
| Gouda | 5.3 ± 2.34 | 3.0 ± 1.73 | 7.5 ± 1.33 | 3.7 ± 1.71 | 6.1 ± 2.22 | 4.5 ± 1.69 |
| Cheese | | | | | | |
| Average | | | | | | |
| Prosciutto | 6.8 ± 1.89 | 3.5 ± 1.94 | 8.3 ± 1.45 | 3.6 ± 1.93 | 7.9 ± 2.01 | 5.0 ± 1.54 |
| Average | | | | | | |

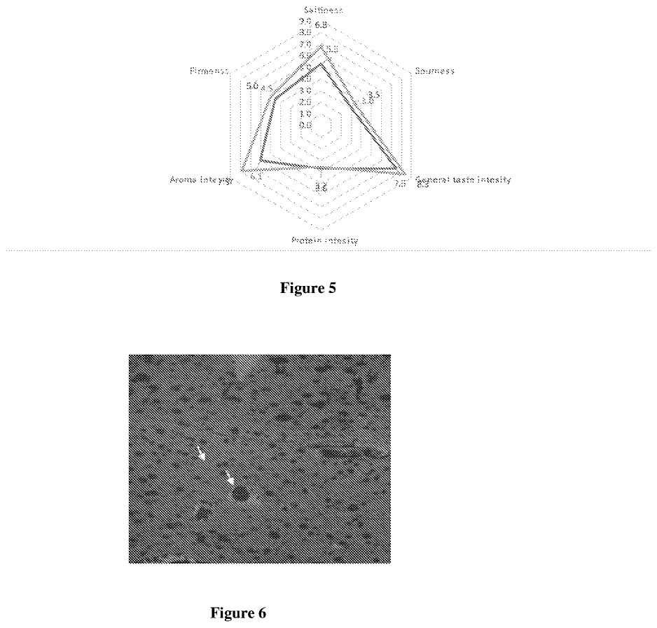

The results shown in Table 6 are represented in a spider plot in FIG. 5.

As the results show, the two products showed similar sensory characteristics although they were different in terms of organoleptic properties, including appearance.

The average protein intensity was 3.7, and 3.6 for the Gouda and prosciutto respectively, significantly lower than the protein intensity of the protein emulsion.

These results suggest that unlike the emulsion in which the protein taste intensity was characterized as very strong, the protein taste intensity in the two food products was reduced.

Taken together the results of Example 1 and this examples, it was suggested that the reduced protein taste observed in the edible product (powder) and in the food product was due to masking of the taste by a unique structure formed by the polymer.

### Example 5: Characterization of Plant-Based Cheese Products Using Confocal Laser Scanning Microscopy (CLSM)

In order to assess the structure morphology of a food product comprising a plant protein and polymer, a gouda cheese was prepared using the components detailed in Table 7.

As described below, bright field microscopy and confocal microscopy were employed to investigate the morphology, structure, and distribution of cellulose, proteins, and lipids in the cheese-like product.

TABLE 7
Compositions of gouda -like cheese

| Component | % |
|---|---|
| Water | 52.00 |
| Yellow lentil protein isolate (88%) | 21.12 |
| (Australian protein company) | |
| refined, bleached, and deodorized coconut | 9.12 |
| oil | |
| Canola oil (liquid) | 9.12 |
| Sunflower Lecithin powder | 1.60 |
| Salt (NaCl) | 1.92 |
| Benecel A4M (Methylcellulose) | 1.60 |
| Flavoring | 2.69 |
| Yeast extract | 0.32 |
| Citric Acid | 0.32 |
| Carotene 30% food coloring (liquid) | 0.14 |
| Coloring Food Paprika Oleoresin (liquid) | 0.05 |

For the preparation of the Plant-based Gouda, Water and lecithin were mixed in a Thermomix at a max speed of 40 degrees for 2 minutes. The oils were added and mixed for a further 10 minutes. After the oil-in-water emulsion was formed, the protein isolate was added to the emulsion and mixed at a medium speed for an additional 10 minutes. Yeast extract, Citric acid, MC, and salt mixed at maximum speed for an additional 10 minutes.

The emulsion was transferred to a mixer and mixed for 60 minutes for cooling and additional mixing with the flavoring and coloring materials. The final mixture was stored in a refrigerator overnight. The product was layered in 3000 microns thickness stainless steel frame to create a film and dried in an MRC drying oven in the middle tray at 80 degrees for 30 minutes. The film was cut from the metal frame sealed in an airtight package and frozen until tasting.

### Methods:

Five layers of gouda cheese were stacked (1.5 cm×1.5 cm×0.7 cm) and embedded in gel. Samples were either embedded in paraffin (Formalin-Fixed Paraffin-Embedded, FFPE block) or OCT (frozen block). Samples were sectioned in microtome (FFPE-5 μm), or cryostat (Frozen blocks-7 μm).

For protein and cellulose detection-FFPE sections were de-paraffinized and stained for fast green or calcofluor white (respectively) and for lipids detection-frozen sections were stained with oil red O and Sudan black B. For each stain, all images were acquired in the same exposure conditions and hence-signal intensity is comparable between samples.

Nonfluorescence chemical signal detection-Bright field microscopy-20× magnification, Zoom. Fluorescence signal detection-Leica TCS SP8 confocal laser-scanning microscope (Leica Microsystems, Germany). Magnification-20×, Zoom.

### Results

The morphology, structure, and distribution of cellulose in the two cheese products were tested using Calcofluor White, that was used to specifically label cellulose.

Confocal images of gouda-like cheese, shown in FIG. 6 reveal a uniform fluorescence signal, suggesting a uniform, continuous and homogeneous distribution of cellulose within the cheese product.

Fast Green FCF staining was utilized to visualize protein distribution and morphology in the examined samples. Both bright-field and confocal microscopy techniques were employed to assess protein structure and distribution in the sample.

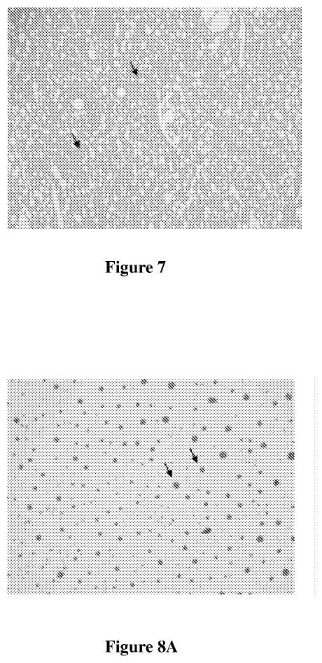

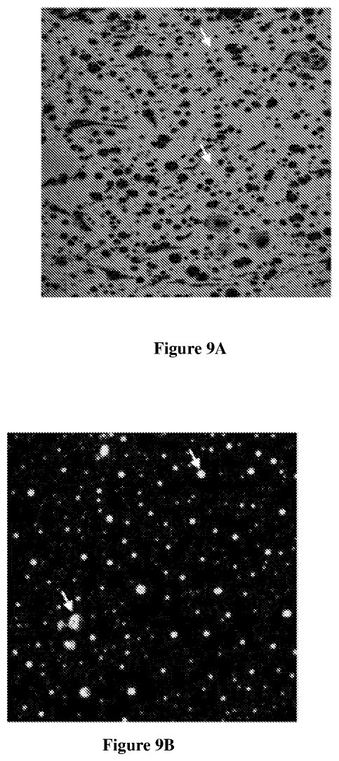

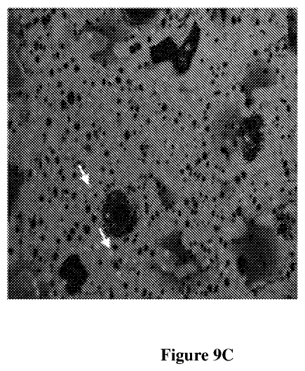

FIG. 7 shows bright field images and FIG. 9A shows confocal images gouda cheese. As can be seen in FIG. 7 and FIG. 9A, protein morphology exhibited a continuous distribution, appearing. The staining intensity was relatively uniform, with proteins displaying a consistent density in the cheese product.

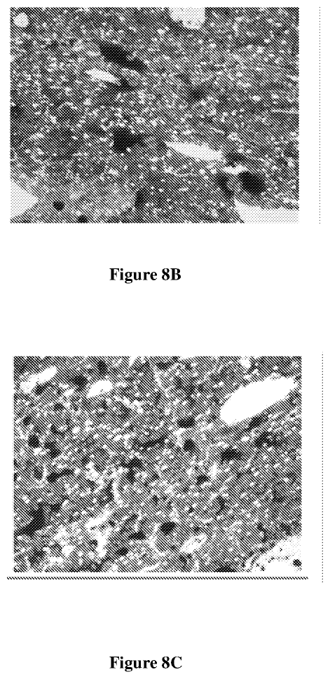

FIG. 8A shows bright field images and FIG. 9B show confocal images of gouda cheese, stained with Oil Red O.

As can be seen in FIG. 8B showing bright field images and FIG. 9C showing confocal images of gouda cheese, exhibited a continuous distribution of phospholipids.

Based on the results of cellulose and protein distribution, it was suggested that the continuous distribution of cellulose and proteins observed in the gouda cheese appeared to be in a form of layers. Without being bound by theory, it was suggested that the polymer that forms layers, such that the protein is held within the layers of the polymer. This form can be characterized by using light microscope or stereoscope.

It was suggested that there may be a matrix that is composed of lipids, proteins, and methylcellulose that is created by the process that may mask the protein off notes created by protein due to encapsulation or chemical interaction with the materials causing changes in the fatty acid and molecules that may cause the off flavors.

### Example 6: Characterization Methods

### Characterization of Sensory Properties

A panel of 8-10 supertasters qualified based on ISO requirements is used to assess the taste of tested products. The panelists are asked to rate given attributes (i.e., descriptors) of foods on a pre-defined scale, or in some cases also provide attributes by themselves. The products are characterized using different attributes including salinity, sweetness, bitterness, and umami. The intensities of each of these attributes are rated on a scale.

### Differential Scanning Calorimetry (DSC)

DSC is used to determine the glass transition temperature (Tg) of the products. The Tg is determined using STARe software (Mettler Toledo) and the exact temperature is taken at the inflection point of the reversing heat flow signal. After equilibration, the exact Aw of the plant protein is analyzed using an AquaLab water activity meter (Decagon Devices, Pullman, USA). Equilibration is performed in triplicate and each repetition is included as a separate point in the plot of Aw against Tg.

### Dissolution Profile of Protein in Saliva Medium

To simulate the oral cavity, a small volume dissolution method is used, with an IKA ULTRATURRAX Tube Drive (IKA Works Inc., USA) equipped with 20 mL mixing vessel. Release of protein from the film or powder is measured using 10 mL of simulated saliva (pH 6.2) with periodic sampling through a cannula connected to a UV cell, which then returned to the mixing vessel. The powder or film is added to the mixing vessel for protein release evaluation. Samples are mixed at 750 rpm and protein release is characterized using online UV-Vis spectrophotometer at 278 nm wavelength at 30 and 60 seconds and intervals for every 10 minutes till 60 minutes.

### Sodium Dodecyl-Sulfate Polyacrylamide Gel Electrophoresis (SDS-PAGE)

This method is carried out to characterize the protein profile (i.e., the different types and amounts of different protein fractions present) of the raw material and to detect possible changes in the protein composition during processing. This is especially relevant for extrusion processes that impose harsh conditions, such as high temperature and shear stress, on the proteins' structure and may promote crosslinking or degradation of the protein, which can be visualized by electrophoresis. This will be done in comparison to our powder, the extrusion is the reference here.

### Near-Infrared (NIR) Spectroscopy

This methos is used to detect differences in the protein, before and after film coating and extrusion.

### Comparative Sample

A plant burger made from TVP can be used as a reference for the nutritional value of the protein.

### Example 7: Plant-Based Protein Product with a Neutral Taste

The preparation of an exemplary plant-based ingredient (edible product) is provided below.

### Materials and Methods

A dispersion composition is prepared including the components of Table 8A:

TABLE 8A
Plant-based protein - dispersion composition (batch size 1605 g)

| Component | Amount per batch (g) |
|---|---|
| Water | 1200 |
| Pea protein | 400 |
| Methylcellulose A4C | 5 |
| Total | 1605 |

Specifically, water is added to a 4 L container and heated to about 70° C. Pea Protein is added to the preheated water and homogenized for about 10 minutes at 21.500 1/min. Methylcellulose, is added while homogenizing for 10 minutes.

The dispersion is transferred to a mixer and stirred at the lowest speed for about 2 hours allowing cooling to ambient temperature until a homogenous dispersion is obtained.

The dispersion is poured on a nonstick liner web, using a tabletop applicator with a 1000 μm gap. The dispersion is dried in an oven at 70° C. for about 50 minutes to obtain a film with a low moisture content.

The film is milled using a standard high-shear grinder to achieve a homogenous powder,

### Results:

The final dried product is a homogenous pea protein powder containing about 1.5% water, a neutral taste and the composition of Table 8B:

TABLE 8B
Pea protein powder - Final Composition

| | Amount per dry |
|---|---|
| Component | basis (%) |
| Pea protein (90% protein content) | 98.8 |
| Methylcellulose A4C | 1.2 |
| Total | 100 |

* The water amount was neglected in the calculation due to low water content (~1.5%).

Description of the Sensory evaluation, DSC, SDS-PAGE, and SEM, NIR, pH shift, Dissolution profile of protein in Saliva medium.

### Example 8: Plant-Based Protein Product with a Neutral Taste

The preparation of an exemplary plant-based ingredient (edible product) is provided below.

### Materials and Methods

An emulsion composition is prepared including the components of Table 9A:

TABLE 9A
Plant-based protein - emulsion composition (batch size 1444 g)

| Component | Amount per batch (g) |
|---|---|
| Water | 1200 |
| Pea protein | 410 |
| Methylcellulose A4M | 34 |
| Lecithin | 10 |
| Canola Oil | 200 |
| Total | 1444 |

Specifically, water is added to a 4 L container and heated to about 70° C. Canola Oil and Lecithin are added to the preheated water and homogenized for about 10 minutes at 21.500 l/min till homogenous emulsion is obtained. Pea protein is added and homogenized for about 10 minutes at 21.500 l/min. Methylcellulose is added and homogenizing for 10 minutes.

The emulsion is transferred to a mixer and stirred at the lowest speed for about 2 hours to cool down to ambient temperature until a homogenous emulsion is obtained.

The emulsion is poured on a nonstick liner web, using a tabletop applicator with a 1000 μm gap. The emulsion is dried in an oven at 90° C. for about 50 minutes to obtain a film with a low moisture content. The film is milled using a standard high-shear grinder to achieve a homogenous powder.

### Results:

The final dried product is a homogenous pea protein powder containing about 1.5% water, a neutral taste and the composition of Table 9B:

TABLE 9B
Pea protein powder - Final Composition

| | Amount per dry |
|---|---|
| Component | basis (%) |
| Pea protein (90% protein content) | 62.7 |
| Methylcellulose A4M | 5.2 |
| Lecithin | 1.5 |
| Canola Oil | 30.6 |
| Total | 100 |

* The water amount was neglected in the calculation due to low water content (~1.5%).

Description of the Sensory evaluation, DSC, SDS-PAGE, CLSM and SEM, NIR, pH shift, Dissolution profile of protein in Saliva medium.

### Example 9: Plant-Based Cold-Cut Made from Pure Sesame Seeds Speared (Tahini)

The preparation of an exemplary plant-based cold-cut is provided below.

### Materials and Methods

An emulsion composition is prepared including the components of Table 10A:

TABLE 10A
Plant-based cold-cut emulsion composition (batch size 970 g)

| Component | Amount per batch (g) |
|---|---|
| Water | 725 |
| Pure Tahini (17% protein content) | 212.7 |
| Methylcellulose A4M | 8 |
| Lecithin | 9 |
| Salt | 6.8 |
| Natural pork flavor | 9 |
| Total | 970 |

Specifically, water is added to a 4 L container and heated to about 70° C. Pure almond butter and Lecithin are added to the preheated water and homogenized for about 10 minutes at 21.500 l/min till homogenous emulsion is obtained. Salt and Nutritional yeast are added and homogenizing for 10 minutes.

Methylcellulose is added and homogenizing for 10 minutes.

The emulsion is transferred to a mixer and stirred at the lowest speed for about 2 hours to cool down to ambient temperature until a homogenous emulsion is obtained.

The emulsion is poured on a nonstick liner web, using a stainless-steel mold of 1500 μm. The emulsion is dried in an oven at 70° C. for about 20 minutes.

The layer is taken out from the oven and emulsion is poured on top of the layer using a stainless-steel mold of 1500 μm, the layers are dried in an oven at 70° C. for about 20 minutes.

The layers are taken out from the oven and emulsion was poured on top of the layers using stainless steel mold 1000 μm. The emulsion was dried in an oven at 70° C. for about 20 minutes. Eventually, a plant-based cold-cut cooked ham style is obtained.

The plant base cold-cut is stored in a refrigerator at 4-8° C. overnight.

### Results:

The final product is a plant-based cold cut, 2500 μm thick, containing about 45% water and the composition of Table 10B:

TABLE 10B
Plant-based cold-cut - Final Composition

| Component | Amount per dry basis (%) |
|---|---|
| Water | 0 |
| Pure almond butter (23.6% protein content) | 86 |
| Methylcellulose A4M | 3.3 |
| Sunflower Lecithin | 3.8 |
| Salt | 2.8 |
| Nutritional yeast | 3.8 |
| Total | 100 |

1. An edible product comprising at least one protein and at least one hydrocolloid polymer, wherein said at least one hydrocolloid polymer is or comprises at least one film forming polymer, said at least one film forming polymer being in a total amount of at least 0.8 wt % out of the total weight of the product, said edible product has an improved one or more sensory characteristics as compared to the one or more sensory characteristics of said at least one protein.

2. The edible product of claim 1, wherein said at least one film forming polymer forms a continuous layered structure in said product.

3. The edible product of claim 1, wherein said at least one film forming polymer forms a polymeric matrix, said polymeric matrix (i) holds within the matrix said at least one protein or (ii) embeds within the matrix said at least one protein.

4. (canceled)

5. The edible product of claim 1, comprising at least one lipid.

6. The edible product of claim 1, wherein said one or more sensory characteristics is or comprises reduced protein taste profile optionally wherein said reduced protein taste profile comprises at least one of (i) reduced protein bitterness, (ii) reduced protein off-flavor, (iii) reduced protein aftertaste, (iv) reduced protein beany taste, or (v) any combination thereof.

7. (canceled)

8. The edible product of claim 1, wherein said at least one hydrocolloid polymer has a viscosity of at least 1,000 cP at 25° C., when dissolved in water, at a concentration of about 1% (w/v).

9. The edible product of claim 1, wherein said at least one film forming polymer is or comprises a polysaccharide.

10. The edible product of claim 9, wherein said polysaccharide is or at least one of methyl cellulose (MC), hydroxypropylmethylcellulose (HPMC), carboxymethylcellulose (CMC), hydroxyethylcellulose, carboxyethylcellulose (CMC), chitosan, methylcellulose, ethylcellulose, xanthan gum, guar gum, gellan gum, gum arabic, carageenan, alginic acid (and its salts), acacia or a combination thereof, optionally wherein said polysaccharide is at least one of MC, HPMC, CMC, xanthan gum, guar gum and or combination of same.

11. (canceled)

12. The edible product of claim 11, wherein said polysaccharide comprises cellulose.

13. The edible product of claim 12, wherein the cellulose is (i) MC having a viscosity of at least about 4,000 cP at 25° C., when dissolved in water at a concentration of about 2 wt % (ii) HPMC having a viscosity at 25° C., of at least about 10,000 cP, or about 15,000 cP, or between about 10,000 cP and about 15,000 cP, when dissolved in water at a concentration of 2 wt %, (iii) CMC having a viscosity at 25° C., of at least about 1,500 cP, or between about 1,500 cP and about 3,000 cP, when dissolved in water at a concentration of 1 wt %, (iv) xanthan gum having a viscosity at 25° C., of between 1,000 cP and about 2,000 cP, when dissolved in water at a concentration of 1 wt %, (v) guar gum having a viscosity at 25° C., of at least about 3,000 cP or between about 3,000 cP and about 5,000 cP, when dissolved in water at a concentration of 1 wt % or (vi) any combination thereof.

14-17. (canceled)

18. The edible product of claim 1, wherein said at least one film forming polymer being in a total amount of at least 1 wt % out of the total weight of the product optionally wherein said at least one film forming polymer being in a total amount of between about 1 wt % and about 20 wt % out of the total weight of the product.

19. (canceled)

20. The edible product of claim 1, wherein said protein is a plant-based protein, optionally wherein said plant-based protein comprises a protein selected from the group consisting of soy, wheat, legume, soy, pea, canola, chickpea, fava bean, lentil, lupin, mung bean, navy bean, peanut, sunflower, almond, corn, oat, potato, quinoa, rice, sorghum, seitan, seeds of sort-chia, hemp, beans of sort-edamame bean, black bean, kidney bean, nuts of sort-cashews, pistachios, walnut, hazelnuts, flax and any combination of same.

21. (canceled)

22. The edible product of claim 20, wherein said plant-based protein legume protein and/or bean protein, optionally wherein said legume protein or bean protein is selected from the group consisting of soy protein, pea protein, chickpea protein, lupine protein, mung-bean protein, kidney bean protein, black bean protein, alfalfa protein and any combination of same.

23. (canceled)

24. The edible product of claim 1, wherein said at least one lipid is or comprises a plant derived oil optionally wherein said plant derived oil is selected from the group consisting of canola oil, coconut oil, and any combination of same.

25. (canceled)

26. The edible product of claim 1, being in one of more of (i) in a form of a powder, (ii) in a form of a film, (iii) in a form of crude material, (iv) in a form of a block, (v) in a form of a texturized protein blend.

27. The edible product of claim 1 being a plant-based chicken meat analogue product, a plant-based ham analogue product, a plant-based bacon analogue product, a plant-based cheese analogue product, a plant-based salmon meat analogue product, a plant-based yellow cheese analogue product, a plant-based hard cheese analogue product.

28. A method for preparing an edible product, the method comprising:
forming a film from a composition comprising at least one protein and at least one hydrocolloid polymer,
at least partially drying the film to obtain the edible product,
wherein said at least one hydrocolloid polymer comprises at least one film forming polymer being in a total amount of at least 0.8 wt % out of the total weight of the product, wherein the edible product is characterized by improved sensory characteristics as compared to the sensory characteristics of said at least one protein.

29. The method of claim 28, comprising (i) milling the edible product to obtain the edible product in a powder form and/or (ii) controlling thickness of the film, optionally wherein said controlling of thickness of the film is by using a gap applicator.

30. The method of claim 28, wherein said forming of the film is by spreading a mass of the emulsion composition onto a film forming bed or within a mold.

31-32. (canceled)

33. The method of claim 28, wherein said at least partially drying of the film is by (i) exposing the film to a controlled heat (ii) any one or combination of heating the film within an oven, exposing the film to drying air, exposing the film to infrared (IR) radiation, heating on a plate or heating within a microwave, optionally said at least partially drying of the film is until water content within the film is between 0.5% and 90%.

34-38. (canceled)
